(19) United States
(12) Patent Application Publication
(10) Pub. No.: US 2024/0404015 A1
(43) Pub. Date: Dec. 5, 2024

(54) METHOD EXECUTED BY ELECTRONIC DEVICE, ELECTRONIC DEVICE, STORAGE MEDIUM AND PROGRAM PRODUCT

(71) Applicant: Samsung Electronics Co., Ltd., Suwon-si (KR)

(72) Inventors: Jianxing ZHANG, Beijing (CN); Zikun LIU, Beijing (CN); Zheng XIE, Beijing (CN); Juan LEI, Beijing (CN); Yuanyang XUE, Beijing (CN); Hyungju CHUN, Suwon-si (KR)

(21) Appl. No.: 18/643,269

(22) Filed: Apr. 23, 2024

Related U.S. Application Data
(63) Continuation of application No. PCT/IB2024/053084, filed on Mar. 29, 2024.

(30) Foreign Application Priority Data
May 30, 2023 (CN) 202310629198.9

(51) Int. Cl. G06T 5/60; G06T 5/77; G06T 7/00; G06V 10/54; G06V 10/60

(52) U.S. Cl. CPC G06T 5/60; G06T 5/77; G06T 7/0002; G06V 10/54; G06T 2200/24; G06T 2207/20081; G06T 2207/20084; G06T 2207/20092; G06T 2207/30168; G06T 2207/30201; G06V 10/60

(57) ABSTRACT

A method performed by an electronic device and an electronic device are provided. The method includes acquiring a first image, determining restoration style information of the first image, and restoring the first image based on the restoration style information by using an artificial intelligence (AI) network to obtain a restored image.

### CROSS-REFERENCE TO RELATED APPLICATION(S)

This application is a continuation application, claiming priority under § 365 (c), of an International application No. PCT/IB2024/053084, filed on Mar. 29, 2024, which is based on and claims the benefit of a Chinese patent application number 202310629198.9, filed on May 30, 2023, in the Chinese Intellectual Property Office, the disclosure of which is incorporated by reference herein in its entirety.

### TECHNICAL FIELD

The disclosure relates to the technical field of artificial intelligence. More particularly, the disclosure relates to a method performed by or executed by an electronic device, an electronic device, a storage media and a program product.

### BACKGROUND ART

With the increasing popularization and alternation frequency of electronic devices, such as mobile phones, users have an increasing demand on the quality of images presented by electronic devices. Therefore, how to improve the image quality has become a continuous goal in this field.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a method performed by or executed by an electronic device, an electronic device, a storage media and a program product to improve the image quality.

Additional aspects will be set forth in part in the description which follows and, in part, will be apparent from the description, or may be learned by practice of the presented embodiments.

In accordance with an aspect of the disclosure, a method performed by an electronic device is provided. The method includes acquiring a first image, determining restoration style information of the first image, and restoring the first image based on the restoration style information by using an artificial intelligence (AI) network to obtain a restored image.

In one optional implementation, the restoration style information is related to attribute information of a target object in the first image.

In one optional implementation, the method further includes determining restoration degree information of the first image, and the restoring the first image based on the restoration style information by using an AI network includes restoring the first image based on the restoration style information and the restoration degree information by using an AI network.

In one optional implementation, the restoration degree information is related to at least one of the image quality of the first image, and a restoration degree related instruction input by a user.

In one optional implementation, the determining of the restoration degree information of the first image includes providing a restoration degree confirmation interface for the first image, and in response to the restoration degree related instruction input by the user through the restoration degree confirmation interface, determining second restoration degree information of the first image.

In one optional implementation, the providing of the restoration degree confirmation interface of the first image includes determining image quality information of the first image, determining corresponding first restoration degree information based on the image quality information, and providing a restoration degree confirmation interface for the first image based on the first restoration degree information, and, in response to the restoration degree related instruction input by the user through the restoration degree confirmation interface, the determining of the second restoration degree information of the first image includes in response to an adjustment instruction to the first restoration degree information input by the user through the restoration degree confirmation interface, determining second restoration degree information of the first image.

In one optional implementation, the determining of the restoration degree information of the first image includes determining image quality information of the first image, and determining corresponding first restoration degree information based on the image quality information.

In one optional implementation, the restoration degree confirmation interface includes at least one of a global restoration degree confirmation interface or at least one local restoration degree confirmation interface, wherein the at least local restoration degree confirmation interface corresponds to at least one local region of the target object.

In one optional implementation, in response to the restoration degree related instruction input by the user through the restoration degree confirmation interface, the determining of the second restoration degree information of the first image includes determining second restoration degree information of the first image in response to at least one of a global restoration degree related instruction input by the user through the global restoration degree confirmation interface, and at least one local restoration degree related instruction input by the user through the at least one local restoration degree confirmation interface.

In one optional implementation, the determining of the corresponding first restoration degree information based on the image quality information includes determining first global restoration degree information based on the image quality information, and determining, based on the image quality information and an image mask of the at least one local region, first local restoration degree information corresponding to the at least one local region respectively, the providing a restoration degree confirmation interface for the first image based on the first restoration degree information includes providing a global restoration degree confirmation interface in the restoration degree confirmation interface based on the first global restoration degree information, and determining, based on the first local restoration degree information corresponding to the at least local region respectively, at least one corresponding local restoration degree confirmation interface in the restoration degree confirmation interface, and, in response to an adjustment instruction to the first restoration degree information input by the user through the restoration degree confirmation interface, the determining of the second restoration degree information of the first image includes determining second restoration degree information of the first image in response to at least one of an adjustment instruction to the first global restoration degree information input by the user through the global restoration degree confirmation interface, and an adjustment instruction to the at least one first local restoration degree information input by the user through the at least one local restoration degree confirmation interface.

In one optional implementation, in response to the restoration degree related instruction input by the user through the restoration degree confirmation interface, the determining of the second restoration degree information of the first image includes in response to the global restoration degree related instruction input by the user through the global restoration degree confirmation interface, determining second global restoration degree information, in response to the at least one local restoration degree related instruction input by the user through the at least one local restoration degree confirmation interface, determining at least one corresponding second local restoration degree information, and fusing the second global restoration degree information and the at least one second local restoration degree information to obtain the second restoration degree information.

In one optional implementation, the determining of the image quality information of the first image includes acquiring depth information and/or lightness information of the first image, and determining the image quality information of the first image based on the lightness information and/or the depth information.

In one optional implementation, the determining of the image quality information of the first image based on the lightness information and/or the depth information includes obtaining a first image feature based on the lightness information and/or the depth information, performing feature extraction on the first image to obtain a second image feature, and determining the image quality information of the first image based on the first image feature and the second image feature.

In one optional implementation, the obtaining of the first image feature based on the lightness information and the depth information includes performing feature extraction on the lightness information and the depth information to obtain a lightness feature and a depth feature, respectively, determining, based on the lightness feature, a first weight map for compensating the depth feature, weighting the depth feature according to the first weight map to obtain a compensated depth feature, and fusing the lightness feature and the compensated depth feature to obtain the first image feature.

In one optional implementation, the determining of the image quality information of the first image based on the first image feature and the second image feature includes determining a second weight map based on the first image feature, the second weight map representing the degree of a correlation between the image quality degradation degree of the first image and the depth information and/or the lightness information, processing the second image feature by using a multi-head self-attention network to obtain a query feature, a key feature and a value feature of the second image feature, weighting the value feature according to the second weight map, and determining the image quality information of the first image based on the weighted value feature, the query feature and the key feature.

In one optional implementation, the method further includes repeating the following update process for at least one time, determining a peak signal to noise ratio of the first image according to the currently obtained restored image, determining a restoration degree information update parameter according to the peak signal to noise ratio, updating the restoration degree information based on the restoration degree information update parameter, and restoring the first image based on the updated restoration degree information to obtain the updated restored image.

In one optional implementation, the determining of the restoration style information of the first image includes determining the attribute information of the target object in the first image according to the first image, and determining restoration style information of the first image based on the attribute information.

In one optional implementation, the determining of the restoration style information of the first image based on the attribute information includes encoding the attribute information into an attribute vector, and mapping the attribute vector into the restoration style information by using a multilayer perceptron network.

In one optional implementation, the restoring of the first image based on the restoration style information by using an AI network includes extracting a corresponding third image feature based on the first image, extracting, based on the restoration style information and from the third image feature, a fifth image feature corresponding to the attribute information of the target object in the first image, and obtaining the restored image based on the third image feature and the fifth image feature.

In one optional implementation, the extracting of the corresponding third image feature based on the first image includes extracting a corresponding third image feature based on the first image and the restoration degree information of the first image.

In one optional implementation, the extracting, based on the restoration style information and from the third image feature, of the fifth image feature corresponding to the attribute information of the target object in the first image includes fusing the restoration style information and the attribute information to obtain a fourth image feature, and obtaining the fifth image feature based on the fourth image feature and the attribute information.

In one optional implementation, the obtaining of the restored image based on the third image feature and the fifth image feature includes determining, according to the correlation between the third image feature and the fifth image feature, an image feature correction amount corresponding to the attribute information, and correcting the third image feature according to the image feature correction amount to obtain the restored image.

In one optional implementation, the third image feature includes at least one dimension, and the determining, according to the correlation between the third image feature and the fifth image feature, of the image feature correction amount corresponding to the attribute information includes for the third image feature of each dimension, determining, according to the correlation between the third image feather of this dimension and the fifth image feature of the corresponding dimension, an image feature correction amount of this dimension corresponding to the attribute information, and the correcting the third image feature according to the image feature correction amount to obtain the restored image includes correcting, according to the image feature correction amount of the at least dimension, the corresponding third image feature to obtain the restored image.

In one optional implementation, the acquiring of the first image includes acquiring a second image, detecting a target object in the second image, and determining a first image based on at least one of the number of the detected target object, the image quality of an image region corresponding to the detected target object, and a target object selection instruction input by the user.

In one optional implementation, the acquiring of the second image includes at least one of acquiring the second image based on the images acquired by an acquisition apparatus in real time, and acquiring the second image based on the images stored in the electronic device.

In one optional implementation, the determining of the first image includes when the number of the detected target object is not less than a first set threshold, determining, based on at least one of the image quality of the image region corresponding to the detected target object or the target object selection instruction input by the user, a first image in the image region corresponding to the target object.

In one optional implementation, the determining, based on the image quality of the image region corresponding to the detected target object, of the first image in the image region corresponding to the target object includes determining the image quality of the image region corresponding to at least one target object, and determining an image region having an image quality correlation value less than a second set threshold as the first image.

In one optional implementation, if the second image is an image acquired by the acquisition apparatus in real time, the method further includes when the number of the detected target object is not less than a third set threshold, storing the second image.

In one optional implementation, the method further includes determining a corresponding third image based on the restored image and the second image, and storing or displaying the third image.

In one optional implementation, the first image is a face image.

In one optional implementation, the attribute information includes at least one of age information, gender information, skin color information, hair information, makeup information and glasses information.

In accordance with another aspect of the disclosure, an electronic device is provided. The electronic device includes memory storing one or more computer programs and one or more processors communicatively coupled to the memory, wherein the one or more computer programs include computer-executable instructions that, when executed by the one or more processors, cause the electronic device to acquire a first image, determine restoration style information of the first image, and restore the first image based on the restoration style information by using an artificial intelligence (AI) network to obtain a restored image.

In accordance with another aspect of the disclosure, a computer-readable storage media is provided. The computer-readable storage media having computer programs stored thereon that, when executed by a processor, implement the method provided in the embodiments of the disclosure.

In accordance with another aspect of the disclosure, one or more non-transitory computer-readable storage media storing computer-executable instructions that, when executed by one or more processors of an electronic device, cause the electronic device to perform operations are provided. The operations include acquiring a first image, determining restoration style information of the first image, and restoring the first image based on the restoration style information by using an artificial intelligence (AI) network to obtain a restored image.

In the method executed by an electronic device, the electronic device, the storage media and the program product provided in the embodiments of the disclosure, by acquiring a first image, determining restoration style information of the first image, and restoring the first image based on the restoration style information by using an AI network to obtain a restored image, the purpose of enhancing the image quality can be achieved.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a flowchart of a method executed by an electronic device according to an embodiment of the disclosure;

FIG. 2 is a schematic diagram of a relationship between a character attribute and a restoration direction according to an embodiment of the disclosure;

FIG. 3 is a schematic diagram of a relationship between an image quality and a restoration intensity according to an embodiment of the disclosure;

FIG. 4 is a schematic diagram of guiding a neural network to restore an image by using an appropriate restoration force in a correct restoration direction according to an embodiment of the disclosure;

FIG. 5A is a schematic diagram of a method for determining image quality information according to an embodiment of the disclosure;

FIG. 5B is a schematic diagram of a method for determining image quality information according to an embodiment of the disclosure;

FIG. 6 is a schematic diagram of controlling a restoration degree according a preference by a user according to an embodiment of the disclosure;

FIG. 7 is a schematic diagram of a method for determining restoration style information according to an embodiment of the disclosure;

FIG. 8 is a schematic diagram of a personalized image restoration method according to an embodiment of the disclosure;

FIG. 9 is a schematic diagram of an attribute feature enhancement module according to an embodiment of the disclosure;

FIG. 10 is a schematic diagram of attribute feature enhancement data according to an embodiment of the disclosure;

FIG. 11 is a schematic diagram of a correction amount weight map according to an embodiment of the disclosure;

FIG. 12 is a schematic diagram of a correction module according to an embodiment of the disclosure;

FIG. 13A is a schematic diagram of a personalized human face restoration method according to an embodiment of the disclosure;

FIGS. 13B and 13C are schematic diagrams of a personalized human face restoration method according to various embodiments of the disclosure;

FIG. 14 is a schematic diagram of a change rule of image quality by visual perception according to an embodiment of the disclosure;

FIG. 15 is a schematic diagram of a relation mapping between a peak signal to noise ratio (PSNR) value and a user's subjective perception according to an embodiment of the disclosure;

FIG. 16 is a schematic diagram of a method for optimizing restoration degree information according to an embodiment of the disclosure;

FIG. 17 is a schematic diagram of a personalized human face redrawing method according to an embodiment of the disclosure;

FIG. 18 is a schematic diagram of a personalized human face redrawing method according to an embodiment of the disclosure;

FIG. 19 is a schematic diagram of a personalized human face redrawing method according to an embodiment of the disclosure;

FIG. 20 is a schematic diagram of a typical camera pipeline of an artificial intelligence (AI) camera according to an embodiment of the disclosure; and

FIG. 21 is a schematic structure diagram of an electronic device according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

When a component is said to be “connected” or “coupled” to the other component, the component can be directly connected or coupled to the other component, or it can mean that the component and the other component are connected through an intermediate element. In addition, “connected” or “coupled” as used herein may include wireless connection or wireless coupling.

The term “include” or “may include” refers to the existence of a corresponding disclosed function, operation or component which can be used in various embodiments of the disclosure and does not limit one or more additional functions, operations, or components. The terms, such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B. When describing multiple (two or more) items, if the relationship between multiple items is not explicitly limited, the multiple items can refer to one, many or all of the multiple items. For example, the description of “parameter A includes A1, A2 and A3” can be realized as parameter A includes A1 or A2 or A3, and it can also be realized as parameter A includes at least two of the three parameters A1, A2 and A3.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

At least some of the functions in the apparatus or electronic device provided in the embodiments of the disclosure may be implemented by an AI model. For example, at least one of a plurality of modules of the apparatus or electronic device may be implemented through the AI model. The functions associated with the AI can be performed through non-volatile memory, volatile memory, and a processor.

The processor may include one or more processors. At this time, the one or more processors may be general-purpose processors, such as a central processing unit (CPU), an application processor (AP), or the like, or a pure graphics processing unit, such as a graphics processing unit (GPU), a visual processing unit (VPU), and/or an AI specialized processor, such as a neural processing unit (NPU).

The one or more processors control the processing of input data according to predefined operating rules or artificial intelligence (AI) models stored in the non-volatile memory and the volatile memory. The predefined operating rules or AI models are provided by training or learning.

Here, providing, by learning, refers to obtaining the predefined operating rules or AI models having a desired characteristic by applying a learning algorithm to a plurality of learning data. The learning may be performed in the apparatus or electronic device itself in which the AI according to the embodiments is performed, and/or may be implemented by a separate server/system.

The AI models may include a plurality of neural network layers. Each layer has a plurality of weight values. Each layer performs the neural network computation by computation between the input data of that layer (e.g., the computation results of the previous layer and/or the input data of the AI models) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GANs), and deep Q-networks.

The learning algorithm is a method of training a predetermined target apparatus (e.g., a robot) by using a plurality of learning data to enable, allow, or control the target apparatus to make a determination or prediction. Examples of the learning algorithm include, but are not limited to, supervised learning, unsupervised learning, semi-supervised learning, or reinforcement learning.

In accordance with the disclosure, in the method executed by an electronic device, the method for image restoration can obtain the restored image or the output data of the image quality of the attribute of the target object in the image by using image data as input data of an AI model. The AI model may be obtained by training. Here, “obtained by training” means that predefined operating rules or AI models configured to perform desired features (or purposes) are obtained by training a basic AI model with multiple pieces of training data by training algorithms.

The method of the disclosure may relate to the visual understanding field of the AI technology. Visual understanding is a technology for recognizing and processing objects like human vision, for example, including object recognition, object tracking, image retrieval, human recognition, scene recognition, 3D reconstruction/positioning or image enhancement.

The technical solutions of the embodiments of the disclosure and the technical effects resulting from the technical solutions of the application are described below by means of a description of several optional embodiments. It should be noted that the following embodiments can be cross-referenced, borrowed or combined with each other, and the description of the same terms, similar features and similar implementation operations or the like, in the different embodiments will not be repeated.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

An embodiment of the disclosure provides a method executed by an electronic device.

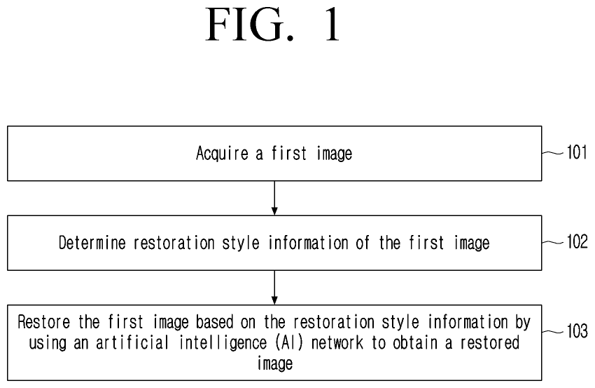

FIG. 1 is a flowchart of a method executed by an electronic device according to an embodiment of the disclosure.

Referring to FIG. 1, the method includes the following operations.

In operation 101, a first image is acquired.

The source of the first image will not be specifically limited in the embodiment of the disclosure. As an example, the first image may be derived from a stored image, for example, an image selected from the photo album, or the like, or, the first image may be derived from an image to be stored, for example, an image shot by the camera in real time, an image downloaded from the network, an image received from another device, or the like. Optionally, the first image may directly use the stored image or the image to be stored, or the stored image or the image to be stored may be processed to some extent and then used as an image to be processed in the subsequent operations 102 and 103. It will not be limited in the embodiment of the disclosure. As an example, if the stored image or the image to be stored contains a plurality of target objects, the plurality of target objects may be divided, and the image where each target object is located is used as a first image. For another example, the image where each target object is located is screened to determine whether this image can be used as a first image for processing in the subsequent operations 102 to 103.

The type of the first image will not be specifically limited in the embodiment of the disclosure. The type of the first image may be different for different application scenarios. As an example, the first image may be a face image (e.g., a human face image, an animal face image), a human shape image, an animal image or other object images. For the convenience of description, the following description may be given by taking a human face image as an example.

In operation 102, restoration style information of the first image is determined.

In the embodiment of the disclosure, for the input low-quality first image, a piece of restoration style information (which may be called restoration style, style, style information or style direction hereinafter, for the convenience of description) will be calculated. The restoration style information may correspond to the characteristics of the first image, and is used to guide the subsequent operations to use an appropriate restoration method to restore the image in a personalized manner.

Optionally, the restoration style information may be related to the attribute information of the target object in the first image. The restoration style information refers to the texture detail feature consistent with the given attribute. In brief, the restoration style information refers to what texture or what type of texture feature should be supplemented in different regions of the input low-quality first image. Restoration style information prediction is to predict various attributes of the target object and map one or more predicted attributes into restoration style information as the restoration direction (the direction consistent with the attribute) for guiding the neural network to restore the texture details of different regions. By taking the first image being a human face image, the target object is a human face. For a low-quality human face image, reasonable and real textures may be added in regions where texture details are missing. The restoration style information predicts various attributes of the human face and maps one or more predicted attributes into the restoration style information. Therefore, the restoration style information may guide the neural network to add reasonable and real textures in regions where the human face image is missing. In practical applications, those skilled in the art can set the attribute type corresponding to the target object according to the actual situation, and it will not be limited in the embodiment of the disclosure. For example, by taking the target object being a human face as an example, the available attribute information includes, but not limited to, at least one of age information, gender information, skin color information, hair information (e.g., hair color, hair curl), makeup information (e.g., whether makeup is put on), glasses information (e.g., whether a pair of glasses is worn, or the type of the worn glasses), or the like. In an example, a man's eyebrows are wide and thick, a woman's eyebrows are narrow and thin, an elder's skin is wrinkled, and a child's skin is smooth.

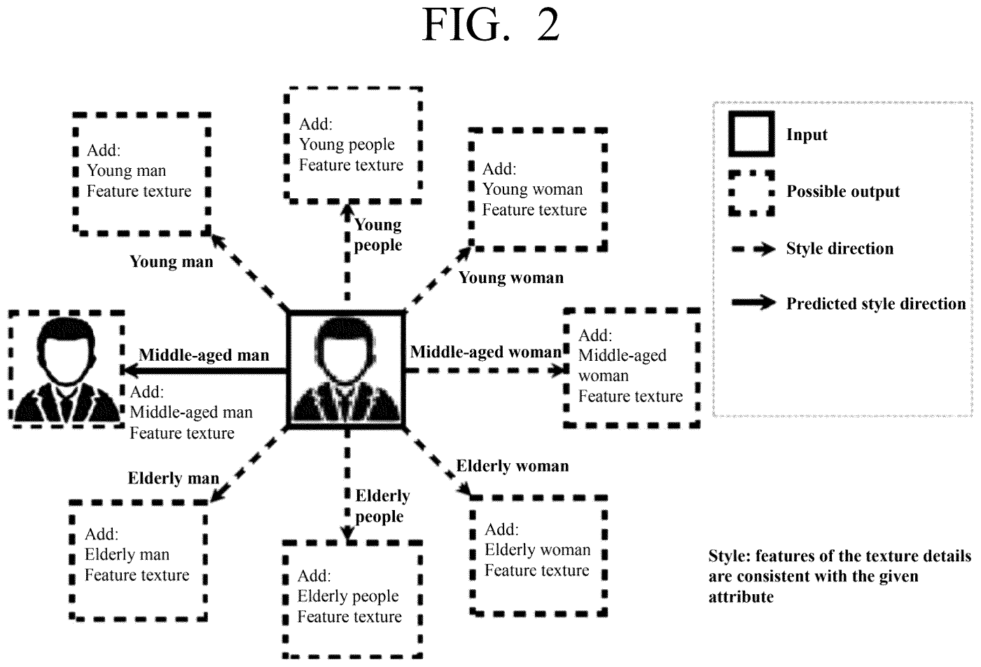

FIG. 2 is a schematic diagram of a relationship between a character attribute and a restoration direction according to an embodiment of the disclosure.

Referring to FIG. 2, for an input human face image, the texture in the corresponding direction may be added to the input human image according to styles, such as young people, young women, middle-aged women, elderly women, elderly people, elderly men, middle-aged men and young men, and the added texture detail feature is consistent with the given attribute, so that high-quality human face images of different styles may be output. According to the attribute of the human face in the input image, usually, one style direction can be selected for restoration. For example, in FIG. 2, the attribute of the human face is middle-aged men, and a high-quality human face image in this style direction can be output based on the predicted restoration style information. It should be understood that only two attributes (i.e., age and gender) are taken into consideration in this example. In practical scenarios, more attributes can be taken into consideration. Since the embodiment of the disclosure improves the image quality based on considering the image style, the missing details can also be restored.

In the embodiment of the disclosure, some implementations of this operation may use an artificial intelligence (AI) network. As an example, the restoration style information of the first image is determined by using a first neural network. In practical applications, those skilled in the art can set the specific neural network used in this operation according to the actual situation, and it will not be limited in the embodiment of the disclosure.

In operation 103, the first image is restored based on the restoration style information by using an AI network to obtain a restored image.

Image restoration is an important branch of the image quality enhancement technology. By taking the first image being a human face image as an example, face restoration is a technology special for improving the image quality of a human face region, and may also be called face redrawing, face hallucination, or the like.

The embodiment of the disclosure aims at restoring (or recovering) the input low-quality first image into a high-quality image and corresponding the restored texture detail to the first image. Low quality means the degradation of the image quality, which may include, but not limited to, noise pollution, image blurring, texture detail loss, artifact, and other degradation conditions or combinations of degradation conditions, for example, pictures shot by a smart phone in low light. In contrast, high quality means that the image has rich texture details and is clean and clear. For example, in the embodiment of the disclosure, the restoration includes, but not limited to, the restoration and generation of details (for example, interpolating a finer texture at a position where the texture is blurred, generating a semantically reasonable, real and natural texture at a position where there is no texture, or the like), image noise reduction, blur elimination to obtain a clear image, or the like.

In the embodiment of the disclosure, some implementations of this operation may also use an AI network. As an example, the first image is restored based on the restoration information by using a second neural network to obtain a restored image. The restoration style information can guide the second AI network to restore the image in the correct restoration direction, so that the second AI network can finally output a high-quality human face image. In practical applications, those skilled in the art can set the specific neural network used in this operation according to the actual situation, and it will not be limited in the embodiment of the disclosure.

In the solutions provided in the embodiment of the disclosure, the input low-quality first image can be restored into a high-quality restored image, and the restoration information corresponds to the characteristics of the first image and is used to guide the neural network model to use an appropriate restoration method to restore the first image, thereby achieving the purpose of personalized enhancement of the image quality.

In one optional implementation, the method executed by an electronic device provided in the embodiment of the disclosure may further include an operation of determining restoration degree information of the first image. Further, the operation 103 may specifically include: restoring the first image based on the restoration style information and the restoration degree information by using an AI network.

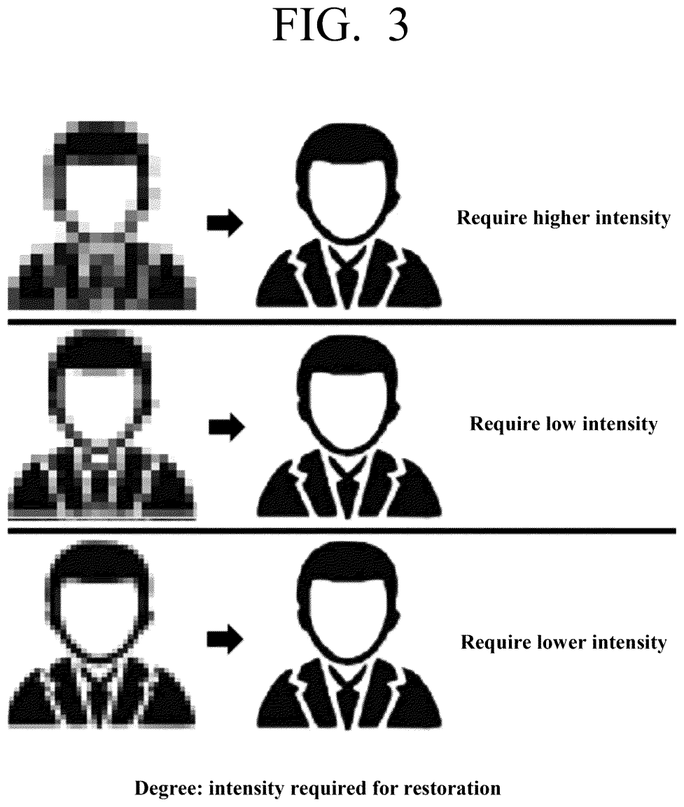

FIG. 3 is a schematic diagram of a relationship between an image quality and a restoration intensity according to an embodiment of the disclosure.

Referring to FIG. 3, optionally, the restoration degree information (which may be called restoration degree, restoration strength or restoration intensity hereinafter, for the convenience of description) is related to at least one of the image quality of the first image, and a restoration degree related instruction input by the user. The restoration degree information may be related to the image quality degradation degree of the first image, and the restoration degree information may be interpreted as the comprehensive reflection of the image quality degradation degree (e.g., the degree of texture detail loss, the degree of noise pollution, or the like) and has nothing to do with the image content. The larger the quality degradation degree is, the larger the image restoration intensity is. By taking the first image being a human face image as an example, for a human face image input with serious quality degradation, high restoration intensity is needed to restore the human face image input into a high-quality output, as shown in the upper part of FIG. 3; for a human face image input with less quality degradation, low restoration intensity is needed to restore the human face image input into a high-quality output, as shown in the middle part of FIG. 3; and, for a human face image input with little quality degradation, a very low restoration intensity is only needed to restore the human face image input into a high-quality output, as shown in the lower part of FIG. 3. The restoration degree information may be related to the restoration degree related instruction input by the user, and the user may set the restoration degree information according to the user's preference (the preference for the image restoration degree). Optionally, a restoration degree confirmation interface, through which the image restoration degree is adjusted or determined, is provided to the user to display the adjustment information of the restoration degree information, so that the user can adjust the restoration degree information, or the user can directly input a restoration degree value in the restoration degree confirmation interface.

In the embodiment of the disclosure, some implementations of the operation 102 may also use an AI network. As an example, the restoration degree information of the first image is determined by using a third neural network. In practical applications, those skilled in the art can set the specific neural network used in this operation according to the actual situation, and it will not be limited in the embodiment of the disclosure.

It is to be noted, the first neural network that determines the restoration degree information and the third neural network that determines the restoration style may be different neural networks, or the first neural network and the third neural network may also be packaged into one neural network. Those skilled in the art can set the architecture of the used neural network according to the actual situation, and it will not be limited in the embodiment of the disclosure.

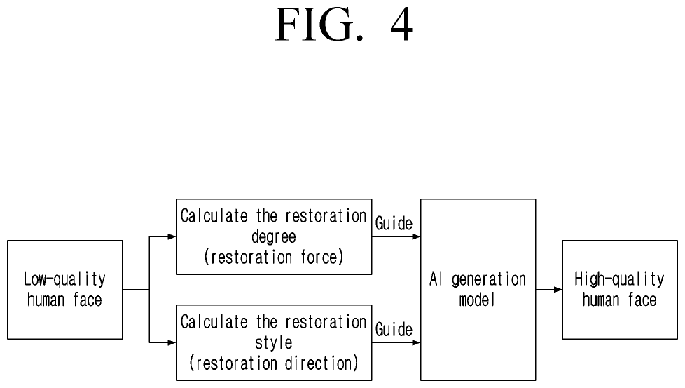

FIG. 4 is a schematic diagram of guiding a neural network to restore an image by using an appropriate restoration force in a correct restoration direction according to an embodiment of the disclosure.

Referring to FIG. 4, in the embodiment of the disclosure, by taking the first image being a human face image as an example, for the input low-quality human face image, the restoration degree may be first calculated to guide the neural network (e.g., the AI generation model) to use an appropriate restoration force to restore the image. Meanwhile, the restoration style information is calculated according to the input first image to guide the neural network to restore the image in the correct restoration direction, so that the neural network can finally output a high-quality human face image.

In the embodiment of the disclosure, a feasible implementation is provided for the operation in operation 102 of “determining the restoration degree information of the first image”. Specifically, this feasible implementation may include the following operations:

In operation SA1, a restoration degree confirmation interface for the first image is provided.

In operation SA2, in response to the restoration degree related instruction input by the user through the restoration degree confirmation interface, second restoration degree information of the first image is determined.

In the embodiment of the disclosure, the restoration degree confirmation interface for the first image is provided to the user. Optionally, the restoration degree confirmation interface is an interface through which the image restoration degree can be adjusted, and the user may adjust the restoration degree information according to the user's preference (the preference for the image restoration degree). For example, the default restoration degree information is displayed in the restoration degree confirmation interface, and the user can adjust the default restoration degree information. Or, the restoration degree confirmation interface is an interface through which an image restoration degree value can be directly input, and the user can input a restoration degree value according to the user's preference (the preference for the image restoration degree), so that the first image is restored by using the corresponding restoration degree value.

After the restoration degree related instruction (e.g., an instruction that the user completes adjustment or an instruction that the restoration degree value is input) input by the user through the restoration degree confirmation interface is detected, in response to the restoration degree related instruction and based on the instruction result (the restoration degree information adjusted or directly input by the user), the second restoration degree information of the first image for indicating the image restoration intensity is determined. By using the second restoration degree information, the neural network can be instructed to use the user-controlled restoration force to restore the first image.

In the embodiment of the disclosure, another feasible implementation is provided for the operation in operation 102 of “determining the restoration degree information of the first image”. Specifically, this feasible implementation may include the following operations:

In an embodiment of the disclosure, image quality information of the first image is determined.

In an embodiment of the disclosure, corresponding first restoration degree information is determined based on the image quality information.

In an embodiment of the disclosure, a restoration degree confirmation interface for the first image is provided based on the first restoration degree information.

In an embodiment of the disclosure, in response to an adjustment instruction to the first restoration degree information input by the user through the restoration degree confirmation interface, second restoration degree information of the first image is determined.

Since the image quality reflects the quality of the image (a good image quality means that the image is clear and has rich texture details and low noise; on the contrary, a poor image quality means that the image is blurred and has high noise and lost texture details, or the like). An image with good quality requires low restoration intensity, while an image with poor quality requires high restoration intensity. By predicting the image quality or its degradation degree, the image restoration degree information can be further predicted.

Therefore, in the embodiment of the disclosure, it is possible to predict the image quality information of the first image first, then determine the recommended initial restoration degree (the first restoration degree information) based on the predicted image quality information, and display the recommended initial restoration degree in the interface (the restoration degree confirmation interface for the first image) provided to the user. For example, in this operation, a reasonable initial restoration degree may be recommended to the user and then adjusted by the user according to the user's preference (including confirming the use of the recommended initial restoration degree) to serve as the guidance information of the final restoration degree.

After it is detected that the user has completed adjustment, in response the adjustment instruction to the first restoration degree information input by the user through the restoration degree confirmation interface, the second restoration degree information of the first image for indicating the image restoration intensity is determined based on the adjustment result (the restoration degree information adjusted by the user) of the adjustment instruction. By using the second restoration degree information, the neural network can be instructed to use an appropriate restoration force to restore the first image.

In the embodiment of the disclosure, still another feasible implementation is provided for the operation in operation 102 of “determining the restoration degree information of the first image”. Specifically, this feasible implementation may include the following operations:

In an embodiment of the disclosure, image quality information of the first image is determined.

In an embodiment of the disclosure, corresponding first restoration degree information is determined based on the image quality information.

In the embodiment of the disclosure, it is possible to predict the image quality information of the first image first and then determine, based on the predicted image quality information, the first restoration degree information for indicating the image restoration intensity. By directly using the first restoration degree information, the neural network is instructed to use an appropriate restoration force to restore the first image. The first restoration degree information already contains the information indicating that different restoration forces are used for texture details in different regions.

In the embodiment of the, a feasible implementation is provided for the operation of “determining the image quality information of the first image”. Specifically, this feasible implementation may include the following operations:

In an embodiment of the disclosure, depth information and/or lightness information of the first image is acquired.

In the embodiment of the disclosure, the way of acquiring the depth information and the lightness information of the first image will not be specifically limited. Optionally, the depth information may be sparse depth information directed obtained by a time of flight (TOF) camera, or may be depth information obtained in other ways. Optionally, the lightness information may be lightness information of the L channel obtained after converting (e.g., by a rgb2lab algorithm, but not limited thereto) the first image to an LAB color space (including a luminosity channel L, a color channel a (from red to green) and a color channel b (from yellow to blue), or may be lightness information obtained in other ways.

In an operation, the image quality information of the first image is determined based on the lightness information and/or the depth information.

This operation is used for exploring the relationship between the depth and lightness and the spatial position, because the inventor of the disclosure has found the degradation degree of the image quality will be different at positions with different depth or different lightness in the image. Therefore, the image quality information of the first image may be determined based on the lightness information and/or the depth information.

In the embodiment of the disclosure, a feasible implementation is provided. Specifically, this feasible implementation may include the following operations.

In an embodiment of the disclosure, a first image feature is obtained based on the lightness information and/or the depth information.

Optionally, after the lightness information and/or the depth information is acquired, feature extraction may be performed on the lightness information and/or the depth information to obtain a corresponding feature (first image feature).

Optionally, to make the depth information more accurate, the depth information may be corrected to some extent in combination with the lightness information of the first image. Specifically, after the lightness is acquired, the depth (information or feature) and the lightness (information or feature) may be fused, the depth information is optimized by using the lightness information to obtain more reliable depth information, and the fused feature map (first image feature) is output.

In an embodiment of the disclosure, feature extraction is performed on the first image to obtain a second image feature.

In practical applications, those skilled in the art can select an appropriate feature extraction method, for example, performing multiple convolution operations on the first image. It will not be limited in the embodiment of the disclosure.

In an embodiment of the disclosure, the image quality information of the first image is determined based on the first image feature and the second image feature.

In the embodiment of the disclosure, the first image feature and the second image feature are combined to explore the correlation between the image quality degradation distribution and the depth information and lightness information, and the image quality information is predicted according to the depth and lightness information so as to predict the more accurate image quality distribution.

In the embodiment of the disclosure, an optional implementation is provided of “obtaining a first image feature based on the lightness information and/or the depth information”.

In an embodiment of the disclosure, feature extraction is performed on the lightness information and the depth information to obtain a lightness feature and a depth feature, respectively.

In practical applications, those skilled in the art can select an appropriate feature extraction method, for example, performing multiple convolution operations on the depth information and the lightness information of the first image, or the like. It will not be limited in the embodiment of the disclosure.

Optionally, the purpose of making the depth information more accurate may be achieved by a spatial adaptive block (SA block). Specifically, the lightness feature and the depth feature are input into the SA block, and the steps shown in the steps SD212 to SD214 will be executed.

In an embodiment of the disclosure, a first weight map for compensating the depth feature is a determined based on the lightness feature.

In practical applications, those skilled in the art can select an appropriate weight determination method, for example, performing a predetermined convolution process on the lightness feature to obtain a first weight map for compensating the depth feature, or the like. It will not be limited in the embodiment of the disclosure.

In the embodiment of the disclosure, considering that pixels with the same lightness are very likely to have similar depths, optionally, the lightness feature is processed by large kernel convolution (e.g., 5×5) to obtain a first weight map (also referred to as a weighted map) for compensating sparse depth information.

In an embodiment of the disclosure, the depth feature is weighted according to the first weight map to obtain a compensated depth feature.

In the embodiment of the disclosure, the depth feature is weighted according to the first weight map to compensate the sparse depth information. For example, a weight value of a pixel is calculated in a wide range of perception field (e.g., the above 5×5) to act on the depth feature of this pixel to correct the depth information.

In an embodiment of the disclosure, the lightness feature and the compensated depth feature are fused to obtain the first image feature.

In the embodiment of the disclosure, the compensated depth information and the lightness information are fused to obtain the fused first image feature for predicting the image quality information of the first image.

In the embodiment of the disclosure, a feasible implementation is provided.

In an embodiment of the disclosure, a second weight map is determined based on the first image feature.

The second weight map represents the degree of correlation between the image quality degradation degree of the first image and the depth information and/or the lightness information.

In practical applications, those skilled in the art can select an appropriate weight determination method, for example, performing a channel attention operation on the first image feature to obtain the second weight map. Specifically, if it is assumed that the first image feature has a size of h×w×c (where c is the number of channels in the channel dimension), a channel attention operation is performed on the fused first image feature. For example, for each pixel, the attention is shifted to the most important channel among c channels to obtain a second weight value (also referred to as a spatial weight map) having a size of h×w×1.

In an embodiment of the disclosure, the second image feature is processed by using a multi-head self-attention network to obtain a query feature, a key feature and a value feature of the second image feature.

For example, in the embodiment of the disclosure, KQV (Key, Query, Value) three branches are obtained based on the extracted second feature image by using a multi-head self-attention network model.

In an embodiment of the disclosure, the value feature is weighted according to the second weight map.

For example, in the embodiment of the disclosure, the second weight map and the above V branch are weighted and fused.

In an embodiment of the disclosure, the image quality information of the first image is determined based on the weighted value feature, the query feature and the key feature.

For example, in the embodiment of the disclosure, the image quality information (which may be an image quality distribution map) is obtained by using the fused V, the K and the Q. After the image quality information is predicted, the restoration degree (distribution) information of the first image may be further obtained.

Optionally, an embodiment of the disclosure may be implemented by a depth and lightness wised multi-head self-attention block (DL-MSA block). Specifically, the first image feature and the second image feature are input into the DL-MSA block, and operations are executed to output the image quality information of the first image.

Considering that there is a nonlinear relationship between the depth and lightness and the image quality degradation, the DL-MSA mainly functions to predict the spatial distribution of image degradation with the depth and lightness by using this correlation. Specifically, the first image feature (depth and/or lightness) is converted into a spatial weight map (second weight map) by a channel attention operation. In the multi-head self-attention of the second image feature, this weight map is applied as a spatial weight onto the (V) value of the second image feature (exploring depth and lightness information). This process may be expressed as:

$$Xout = SelfAttention ( X 1 ) ⊗ ( ( X 1 WV ) ⊙ ( softmax ) ( X 0 W ) ) )$$

where X0 represents the first image feature; X0W represents the feature obtained after performing the channel attention operation on the first image feature; softmax (X0W) represents the second weight map (activated by a softmax activation function); X1 represents the second image feature; X1WV represents the V feature of the second image feature; ⊙ (represent weighting; SelfAttentio(X1) represents the self-attention feature obtained after fusing the K feature and the Q feature of the second image feature; and, ⊗ represents fusion.

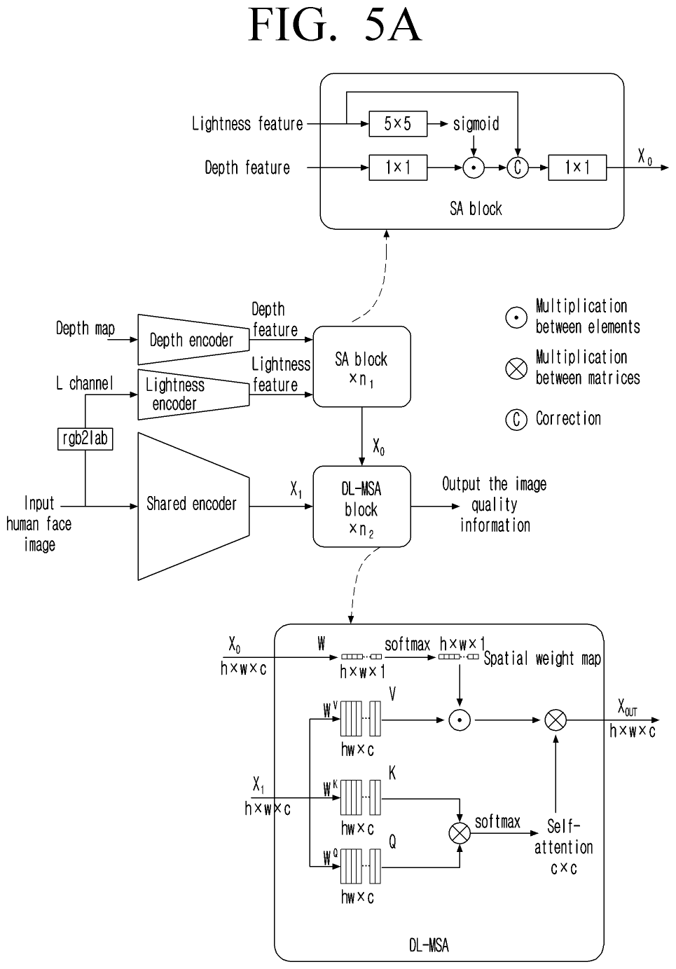

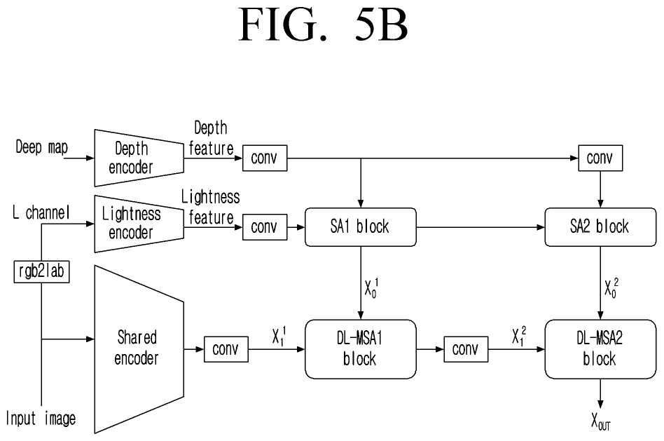

FIG. 5A is a schematic diagram of a method for determining image quality information according to an embodiment of the disclosure.

Referring to FIG. 5A, based on at least one of the above embodiments of the disclosure, an embodiment of the disclosure shows a complete process instance of determining the image quality information of the first image by taking the first image being a human face image. As shown in FIG. 5A, the following operations may be included specifically:

In operation 5.1, a depth map (i.e., depth information) of the input human face image is acquired, and feature extraction is performed on the depth map by a depth encoder to obtain a depth feature.

in operation 5.2, the input human face image is converted to an LAB color space by a rgb2lab algorithm, the lightness information of the L channel is acquired, and feature extraction is performed on the lightness information by a lightness encoder to obtain a lightness feature.

In operation 5.3, the depth feature and the lightness feature are processed by n1 SA blocks. The processing process of the SA blocks may be described below. The lightness feature is convolved by 5×5 large kernel convolution, and the result of lightness convolution is processed by an activation function (e.g., sigmoid, but not limited thereto) to obtain a first weight map; the depth feature is convolved by 1×1 kernel convolution, and the result of depth convolution is weighted by using the first weight map (multiplication between elements); the lightness feature and the weighted result are fused by a correction module to correct the depth feature; and, the result of fusion is convolved by 1×1 kernel convolution to a first image feature X0.

In operation 5.4, feature extraction is performed on the input human face image by a shared encoder to obtain a second image feature X1.

In operation 5.5, the first image feature X0 and the second image feature X1 are processed by n2 DL-MSA blocks. The processing process of the DL-MSA blocks is described below. An channel attention operation is performed on the first image feature having a size of h×w×c to obtain an image feature W having a size of h×w×1; the image feature W is processed by an activation function (e.g., softmax, but not limited thereto) to obtain a spatial weight map (second weight map) having a size of h×w×1; the second image feature X1 having a size of h×w×c is processed by using a multi-head self-attention network model to obtain KQV three branches, so as to obtain a feature WK, a feature WQ and a feature WV each having a size of hw×c, the feature Wv is weighted by using the second weight map (multiplication between elements) to obtain the weighted V feature; the feature WK and the feature WQ are fused (multiplication between matrices) and processed by an activation function (e.g., softmax, but not limited thereto) to obtain a self-attention feature having a size of c×c, and, the weighted V feature and the self-attention feature are fused (multiplication between matrices) to obtain image quality information Xout having a size of h×w×c.

In another example, the number n1 of the SA blocks may be equal to the number n2 of the DL-MSA blocks.

FIG. 5B is a schematic diagram of a method for determining image quality information according to an embodiment of the disclosure.

Referring to FIG. 5B, by taking n1=n2=2 as an example, the specific processing process may include the following:

A depth map (i.e., depth information) of the input image is acquired, and feature extraction is performed on the depth map by a depth encoder to obtain a depth feature. The input image is converted to an LAB color space by a rgb2lab algorithm, the lightness information of the L channel is acquired, and feature extraction is performed on the lightness information by a lightness encoder to obtain a lightness feature. The depth feature and the lightness feature are convolved and then input into a first SA block (SA1 block) and a second SA block (SA2 block) for processing to obtain a first image feature X_0\hat{ }1 and a first image feature X_0\hat{ }2, respectively. Feature extraction is performed on the input image by a shared encoder, and then convolved to obtain a second image feature X_1\hat{ }1. The first image feature X_0\hat{ }1 and the second image feature X_1\hat{ }1 are processed by a first DL-MSA block (DL-MSA1 block), and the result of processing is convolved to obtain an updated second image feature X_1\hat{ }2. The first image feature X_0\hat{ }2 and the second image feature X_1\hat{ }2 are processed by a second DL-MSA block (DL-MSA2 block) to obtain image quality information X_OUT. It is not hard to understand that a case of more SA blocks and more DL-MSA blocks may be analogized until the last DL-MSA block outputs the image quality information X_OUT, and the similar process will not be repeated.

In the embodiment of the disclosure, the above restoration degree confirmation interface may include at least one of the following functions: a global adjustment function and a local adjustment function. Both the global adjustment function and the local adjustment function may be controlled by the user according to the user's preference.

In one optional implementation, the restoration degree confirmation interface includes at least one of the following: a global restoration degree confirmation interface and at least one local restoration degree confirmation interface, wherein the at least local restoration degree confirmation interface corresponds to at least one local region of the target object.

In practical applications, those skilled in the art can set the display mode of the global restoration degree confirmation interface and the at least one local restoration degree confirmation interface according to the actual situation. For example, the global restoration degree confirmation interface and the at least one local restoration degree confirmation interface may be displayed simultaneously, for example, being displayed as sub-interfaces in different regions of one interface; or, the global restoration degree confirmation interface and the at least one local restoration degree confirmation interface may be displayed sequentially. For example, the global restoration degree confirmation interface is displayed first, and then one or more local restoration degree confirmation interfaces are displayed after the related instruction of the global restoration degree confirmation interface is input. It will not be limited in the embodiment of the disclosure.

For example, in the embodiment of the disclosure, the control of the image restoration degree provided to the user includes global control and local control. Optionally, the default restoration degree recommended to the user may include a global default restoration degree (displayed in the global restoration degree confirmation interface) and a local default restoration degree of a local region (displayed in the corresponding local restoration degree confirmation interface); or optionally, the entry that provides the user to input the restoration degree value may include a global default restoration degree entry (displayed in the global restoration degree confirmation interface) and a local default restoration degree entry of a local region (displayed in the corresponding local restoration degree confirmation interface). In practical applications, those skilled in the art can set the type (e.g., corresponding to which local region or regions of the target object), number, and specific numerical value of the restoration degree information according to the actual situation, and it will not be limited in the embodiment of the disclosure.

In an embodiment of the disclosure second restoration degree information of the first image is determined in response to at least one of the following instructions: a global restoration degree related instruction input by the user through the global restoration degree confirmation interface, and at least one local restoration degree related instruction input by the user through the at least one local restoration degree confirmation interface.

For example, in this operations, the user may input the related instruction in only one restoration degree confirmation interface (e.g., the global restoration degree confirmation interface or any local restoration degree confirmation interface), and other interfaces will remain unchanged or have no input; or, the user may input the corresponding related instructions in a plurality of restoration degree confirmation interfaces.

In the embodiment of the disclosure, in response to the related instruction input in one or more restoration degree confirmation interfaces, the second restoration degree information of the first image is determined to indicate a degree to which the first image is to be restored at a different spatial position. This degree is used for guiding the degree of image restoration in the personalized human face restoration process.

In the embodiment of the disclosure, a feasible implementation is provided.

In an embodiment of the disclosure first global restoration degree information is determined based on the image quality information.

In an embodiment of the disclosure based on the image quality information and an image mask of at least one local region, first local restoration degree information corresponding to the at least one local region is determined.

For example, in the embodiment of the disclosure, the adjustment to the image restoration degree provided to the user includes global adjustment and local adjustment. Specifically, the initial restoration degree (first restoration degree information) recommended to the user may include a global initial restoration degree (first global restoration degree information) and a local initial restoration degree (first local restoration degree information) of the local region.

The embodiment of the disclosure may specifically include the following operations:

In an embodiment of the disclosure a global restoration degree confirmation interface is provided in the restoration degree confirmation interface based on the first global restoration degree information.

In an embodiment of the disclosure at least one corresponding local restoration degree confirmation interface is provided in the restoration degree confirmation interface based on the first local restoration degree information corresponding to the at least local region.

Similarly, those skilled in the art can set the display mode of the global restoration degree confirmation interface and the at least one local restoration degree confirmation interface according to the actual situation. For example, the global restoration degree confirmation interface and the at least one local restoration degree confirmation interface may be displayed simultaneously, for example, being displayed as sub-interfaces in different regions of one interface, or, the global restoration degree confirmation interface and the at least one local restoration degree confirmation interface may be displayed sequentially. For example, the global restoration degree confirmation interface is displayed first, and then one or more local restoration degree confirmation interfaces are displayed after the related instruction of the global restoration degree confirmation interface is input. It will not be limited in the embodiment of the disclosure.

In the embodiment of the disclosure, the local region may be determined by using a corresponding image mask. In practical applications, those skilled in the art can set the type and number of local regions (image masks) according to the actual situation, and it will not be limited in the embodiment of the disclosure. By taking the first image being a human face image as an example, the type of local regions (image masks) may include, but not limited to, eye, mouth, skin, hair, or the like. Each local region (image mask) may be obtained in various ways. For example, each local region of the human face image is obtained according to a human face resolution graph. In practical applications, the global region may also be interpreted as a mask image corresponding to one global region.

Specifically, the overall average level of the image quality information may be calculated, that is, the average value of all pixels in the image quality information is calculated; and then, the first global restoration degree information recommended to the user is determined based on the overall average level.

In an embodiment of the disclosure the average level corresponding to at least one local region of the image quality information may be calculated, that is, for each local region in the at least one local region of the image quality information, the average value of all pixels in this local region is calculated (it can also be interpreted as the average value of all pixels in the image quality information after multiplying the local mask image); and then, the first local restoration degree information corresponding to the at least one local region recommended to the user is determined based on the average level corresponding to the at least one local region.

Further, a feasible implementation is provided.

In an embodiment of the disclosure second restoration degree information of the first image is determined in response to at least one of the following instructions: an adjustment instruction to the first global restoration degree information input by the user through the global restoration degree confirmation interface, and an adjustment instruction to the at least one local restoration degree information input by the user through the at least one local restoration degree confirmation interface.

For example, in the embodiment of the disclosure, the first global restoration degree information and the first local restoration degree information corresponding to the at least one local region may be controlled by the user according to the user's preference. The control variables (the amount of change before and after adjustment) may be interpreted as weighting factors for the image restoration degree of the global region or the local region. These variables may establish a bridge between the model and the user, so that the user can control the image restoration degree according to the user's preference, thereby realizing personalized human face image enhancement.

The adjustable user interface includes: a global adjustment function (corresponding to the first global restoration degree information, where the user can adjust the overall restoration degree of the image and display it in the global restoration degree confirmation interface) and a local adjustment function (corresponding the first local restoration degree information corresponding to the at least one local region, where the user can adjust the image restoration degree for different local regions, e.g., the eye, mouth, skin, hair or the like in the human face, and display it in the corresponding local restoration degree confirmation interface).

In this operations, the user may input the adjustment instruction in only one restoration degree confirmation interface (e.g., the global restoration degree confirmation interface or any local restoration degree confirmation interface), and other interfaces will remain unchanged; or, the user may input the adjustment instruction in a plurality of restoration degree confirmation interfaces.

For example, in the embodiment of the disclosure, in response to the adjustment instruction input in one or more restoration degree confirmation interfaces, the second restoration degree information of the first image is determined to indicate a degree to which the first image is to be restored at a different spatial position. This degree is used for guiding the degree of image restoration in the personalized human face restoration process.

In the embodiment of the disclosure, a feasible implementation is provided.

In an embodiment of the disclosure in response to the global restoration degree related instruction input by the user through the global restoration degree confirmation interface, second global restoration degree information is determined.

In some of the above embodiments of the disclosure, the global restoration degree related instruction may also refer to the adjustment instruction to the first global restoration degree information input by the user through the global restoration degree confirmation interface.

In an embodiment of the disclosure in response to the at least one local restoration degree related instruction input by the user through the at least one local restoration degree confirmation interface, at least one corresponding second local restoration degree information is determined.

In some of the above embodiments of the disclosure, any local restoration degree related instruction may also refer to the adjustment instruction to the corresponding first local restoration degree information input by the user through the corresponding local restoration degree confirmation interface.

In an embodiment of the disclosure the second global restoration degree information and the at least one second local restoration degree information are fused to obtain the second restoration degree information.

In one optional implementation, a global adjustment value and a local adjustment value are obtained as adjustment results according to the second global restoration degree information and the at least one second local restoration degree information, global adjustment and local adjustment are performed on the image quality information (e.g., the image quality distribution map) based on the global adjustment value and the local adjustment value to obtain second global restoration degree information and at least one second local restoration degree information, and the second global restoration degree information and the at least one second local restoration degree information are fused to obtain an image restoration degree control map (second restoration degree information). The control map is a weight value map having the same size as the first image, indicating a degree to which the image is to be restored at a different spatial position. This degree is used for guiding the degree of image restoration in the personalized human face restoration process.

It should be understood that, for a restoration degree conformation interface where the user does not input an adjustment instruction, the corresponding first (global or local) restoration degree information and the second (global or local) restoration degree information may be the same, that is, the (global or local) adjustment value is zero.

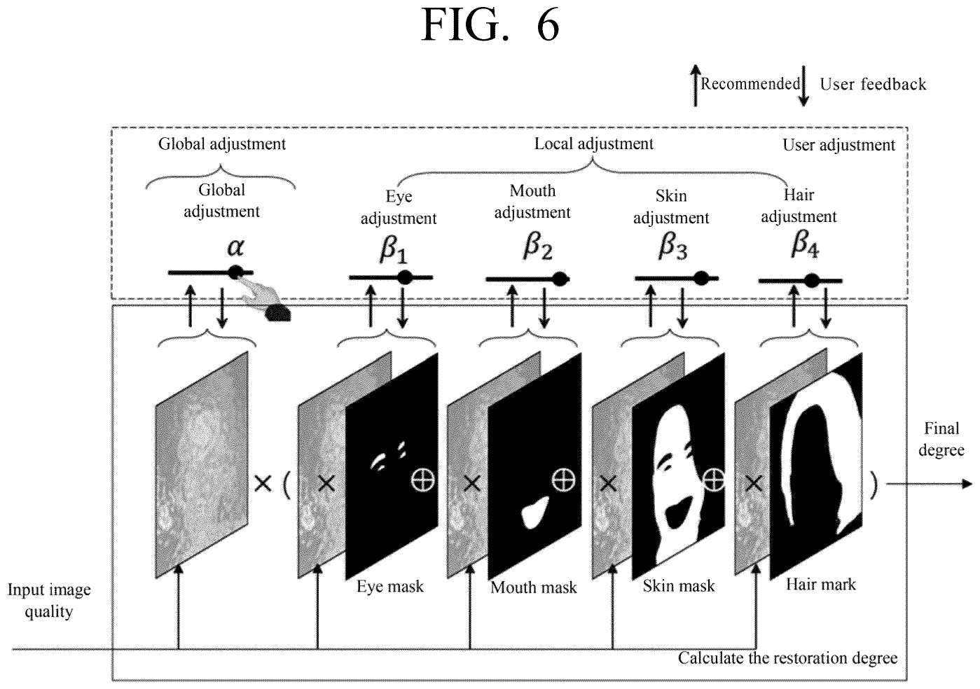

FIG. 6 is a schematic diagram of controlling a restoration degree according a preference by a user according to an embodiment of the disclosure.

Referring to FIG. 6, an example of controlling the restoration degree information by the user according to the user's preference by taking the first image being a human face image as an example. Specifically, the following operations are included.

In operation S6.1, the input image quality information is acquired.

In operation S6.2, the overall average level of the image quality information (optionally, overlapped with the image mask of the global region) is calculated, and the first global restoration degree information α recommended to the user is determined based on the overall average level and displayed in the provided interface (global restoration degree confirmation interface).

In operation S6.3, the average level of the eye region of the image quality information is calculated based on the image mask of the eye region, and the first local restoration degree information β1 recommended to the user is determined based on the average level of the eye region and displayed in the provided interface (the local restoration degree confirmation interface corresponding to the eye region).

In operation S6.4, the average level of the mouth region of the image quality information is calculated based on the image mask of the mouth region, and the first local restoration degree information β2 recommended to the user is determined based on the average level of the mouth region and displayed in the provided interface (the local restoration degree confirmation interface corresponding to the mouth region).

In operation S6.5, the average level of the skin region of the image quality information is calculated based on the image mask of the skin region, and the first local restoration degree information β3 recommended to the user is determined based on the average level of the skin region and displayed in the provided interface (the local restoration degree confirmation interface corresponding to the skin region).

In operation S6.6, the average level of the hair region of the image quality information is calculated based on the image mask of the hair region, and the first local restoration degree information β4 recommended to the user is determined based on the average level of the hair region and displayed in the provided interface (the local restoration degree confirmation interface corresponding to the skin region).

In operation S6.7, α, β1, β2, β3 and 84 may be controlled by the user according the user's preference. The user's control operation to at least one of the first global restoration degree information α and the first local restoration degree information β1, β2, β3 and β4 (the input adjustment instruction to the first restoration degree information) in the provided interface is received to obtain the corresponding adjustment amounts Δα, Δβ1, Δβ2, Δβ3 and Δβ4.

In operation S6.8, the final second restoration degree information is calculated according to the image quality information and the adjustment amounts Δα, Δβ1, Δβ2, Δβ3 and Δβ4. Optionally, the calculation may be expressed by the following formula:

$$final degree = Q ⊕ Δ α ⊕ Δ β 1 \times maskeye ⊕ Δ β 2 \times maskmouth ⊕ Δ β 3 \times maskskin ⊕ Δ β 4 \times maskhair$$

where final degree represents the final second restoration degree information; Q represents the image quality information; A represents the difference between the recommended value and the user feedback value; Aa represents the adjustment amount of the global restoration degree information; Δβ1, Δβ2, Δβ3 and Δβ4 represent the adjustment amounts of the local restoration degree information of the eye region, the mouth region, the skin region and the hair region, respectively; Q⊕Δα represents the second global restoration degree information; maskeye, maskmouth, maskskin and maskhair represent the image masks of the eye region, the month region, the skin region and the hair region, respectively; Q⊕Δβ1×maskeye, Q⊕Δβ2×maskmouth, QβΔβ3×maskskin and Q⊕Δβ4×maskhair represent the second local restoration degree information of the eye region, the mouth region, the skin region and the hair region, respectively; @ represents the addition of elements; and, Δα, Δβ1, Δβ2, Δβ3, Δβ4€ [0,1].

It should be understood that the user can realize different global control effects by only adjusting the global restoration degree information α, for example, adjusting α as α=0.1, α=0.4, α=0.5, α=0.7 or α=0.9, or the like. Or, the user can adjust the image quality of a certain region according to the user's preference, to realize the spatial decoupling of the semantic regions, such as eye, mouth, skin and hair of the human face. For example, the local restoration degree information 1 of the eye region is adjusted as β1=0.1, 81=0.3, or the like, to realize different control effects of the eye region.

In the embodiment of the disclosure, a feasible implementation is provided for the operation in operation S102 of “determining the restoration style information of the first image”. Specifically, this feasible implementation may include the following operations.

In operation SE1, the attribute information of the target object in the first image is determined according to the first image.

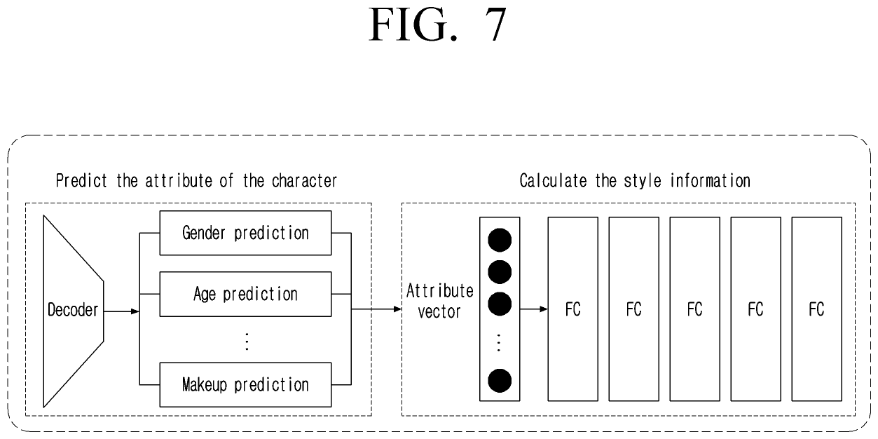

FIG. 7 is a schematic diagram of a method for determining restoration style information according to an embodiment of the disclosure.

Referring to FIG. 7, by taking the first image being a human face image and the target object being a human face as an example, the input first image may be processed by a decoder to predict various attributes of the target object, e.g., age prediction, gender prediction, makeup prediction, glasses prediction, hair color prediction, hair curl prediction, or the like, but not limited thereto.

In an embodiment of the disclosure the restoration style information of the first image is determined based on the attribute information.

Optionally, the restoration style information may be style control codes, which are the reflection of personalized human face features. The style information may be used as prior knowledge to provide the personalization direction.

Optionally, the embodiment of the disclosure may specifically include the following operations:

In an embodiment of the disclosure the attribute information is encoded into an attribute vector.

In an embodiment of the disclosure the attribute vector is mapped into the restoration style information by using a multilayer perceptron network.

If there are a plurality of attributes, the plurality of predicted attributes may be jointly encoded into an attribute vector.

Further, the attribute vector may be mapped into the restoration style information by using a multilayer perceptron (MLP) network, and the layers of the MLP are fully connected (FC) layers.

Therefore, in the embodiment of the disclosure, by predicting the attribute information of the human face and calculating the human face restoration style information according to the human face attribute to guide the style/direction of human face restoration, the restoration of the personalized feature consistent with the character attribute can be guided in the human face restoration process.

In the embodiment of the disclosure, in a case where the restoration information includes the restoration degree information and the restoration style information, an optional implementation is provided, where personalized restoration is performed on the first image by using the predicted restoration degree information and restoration style information. Specifically, this feasible implementation may include the following operations:

In an embodiment of the disclosure a corresponding third image feature is extracted based on the first image.

In an embodiment of the disclosure a fifth image feature corresponding to the attribute information of the target object in the first image is extracted from the third image feature based on the restoration style information.

In an embodiment of the disclosure the restored image is obtained based on the third image feature and the fifth image feature.

In an embodiment of the disclosure a deep feature code (third image feature) of the first image is extracted by a deep feature extraction network (e.g., an encoder).

Optionally, if the restoration degree information of the first image is determined, an embodiment of the disclosure may specifically include: extracting a corresponding third image feature based on the first image and the restoration degree information of the first image.

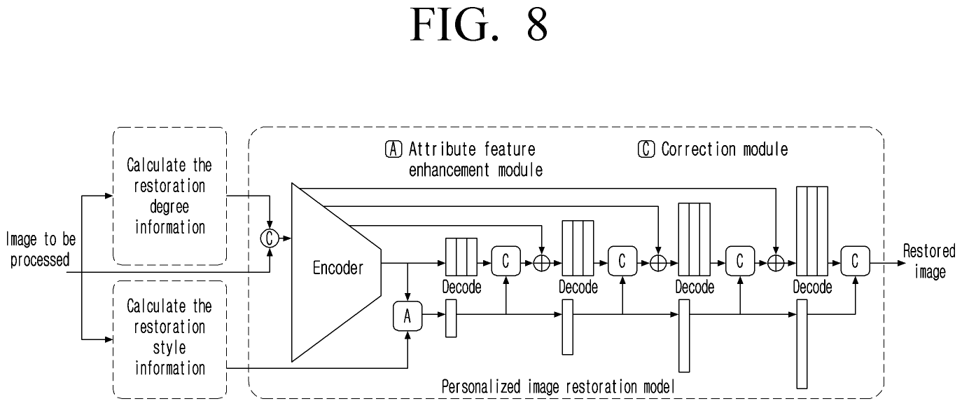

Optionally, the calculated restoration degree information (e.g., which may be a restoration degree control map) of the first image is superposed with the first image (which may also be interpreted as correction), and a deep feature code (third image feature) is extracted by using a deep feature extraction network (e.g., an encoder), as shown in FIG. 8.

FIG. 8 is a schematic diagram of a personalized image restoration method according to an embodiment of the disclosure.

Referring to FIG. 8, since the restoration degree information is related to the spatial position, different regions have different image qualities. Alignment and superposition can extract more meaningful image features and can accurately reflect the degree to which the image quality is to be restored.

In practical applications, the encoder can extract a third image feature of one or more dimensions (taking 4 dimensions as an example in FIG. 8). Those skilled in the art can set the number of dimensions extracted by the encoder according to the actual situation, and it will not be limited in the embodiment of the disclosure.

Further, in an embodiment of the disclosure modulation information (fifth image feature) is extracted from the third image feature extracted by using the restoration style information (e.g., which may be the style control code). The restoration style information is obtained after encoding the attribute of the target object in the image. A feature matched with the style is found according to the style in the encoded feature, a correction amount is calculated on the encoder by using the decoded feature of the first image. It is equivalent to calculating how many style content components are needed in the current feature. Then, reasonable restoration is performed. If the third image feature includes a plurality of dimensions, the extracted fifth image feature may also correspond to a plurality of dimensions. For example, in FIG. 8, a fifth image feature of 4 dimensions is extracted.

Optionally, the extraction of the modulation information from the third image feature by using the restoration style information may be realized by an attribute feature enhancement module, and the extracted modulation information is essentially a deep image feature consistent with the associated attribute (the fifth image feature corresponding to the attribute information of the target object in the first image). The attribute is related to texture features, but these features are not clear. The core function of this module has two aspects: (1) selecting a feature related to the associated attribute; and (2) adapting the selected feature to the associated attributed. The output of this module enhances the feature related to the associated attribute and is used as the modulation information in the decoding process. Optionally, to improve the calculation efficiency, the attribute feature enhancement module may only be executed on the smallest resolution scale.

Furthermore, the decoded feature of the third image feature is corrected by using the modulation information (fifth image feature), for example, by a correction module, so that the personalized restored image is finally restored. The correction module functions to correct the deviation of the restored feature according to the associated attribute. This module is suitable for all resolution ratios except for the smallest decoder. If the third image feature includes a plurality of dimensions, the third image feature of a different dimension (starting from the second dimension, the third image feature will be added with the correction result of the previous dimension to serve as the third image feature of the current dimension) is corrected by using the fifth image feature of the corresponding dimension, as shown in FIG. 8.

Thus, personalized restoration can be performed on the input low-quality first image by using the restoration degree information (e.g., the restoration degree control map) and the restoration style information (e.g., the style control code).

In a first aspect, the predicted restoration degree information is related to the spatial position in the first image. Different spatial regions have different image qualities and different image restoration degrees. The restoration degree information is aligned and superposed with the first image on the spatial position, so that it is convenient to explore the spatial distribution of the image quality and guide the model to realize different restoration intensities in different regions.

In a second aspect, the restoration degree information can realize the user's preference control based on the regional restoration degree.

In a third aspect, the restoration style information is used to extract the modulation information from the deep feature of the first image. Then, such information can modulate the decoded features of different dimensions and guide the model to add reasonable and real textures (consistent with the multiple predicted attributes) in regions where the texture details are missing.

In the embodiment of the disclosure, an optional implementation is provided. Specifically, this optional implementation may include the following operations:

In an embodiment of the disclosure the restoration style information and the attribute information are fused to obtain a fourth image feature.

In an embodiment of the disclosure a fifth image feature is obtained based on the fourth image feature and the attribute information.

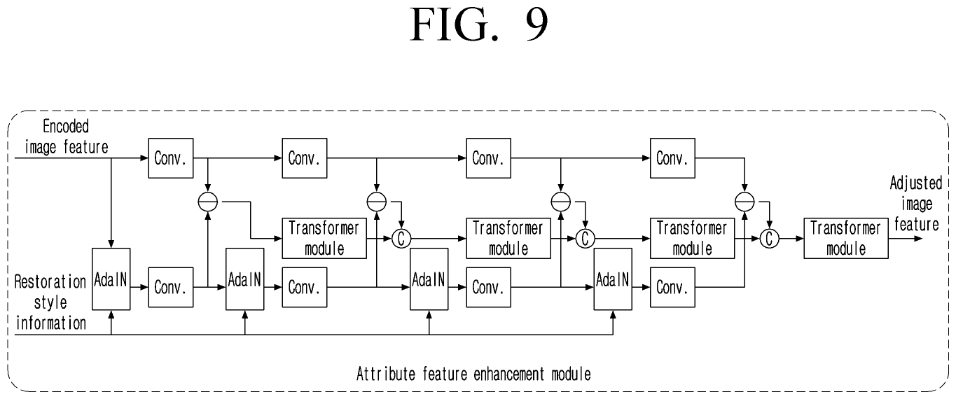

Optionally, in an embodiment of the disclosure a feature consistent with the predicted attribute is enhanced in the third image feature (the encoded image feature) based on the restoration style information (for example, which may be the style control code) by using an attribute feature enhancement module, to obtain a fourth image feature with the enhanced associated attribute, as shown in FIG. 9.

FIG. 9 is a schematic diagram of an attribute feature enhancement module according to an embodiment of the disclosure.

Referring to FIG. 9, optionally, the restoration style information is continuously introduced into the third image feature by adaptive instance normalization (AdaIN), so that the common information is weakened and the image feature associated with the attribute is enhanced. This process may be expressed as follows:

$$AdaIN ( x , y ) = σ ( y ) ( ( x - μ ( x ) ) / σ ( x ) ) + μ ( y )$$

where AdaIN(x,y) represents the fourth image feature; x represents the third image feature; y represents the restoration style information; σ and μ are the mean value and the standard deviation, respectively, and the mean value and the standard deviation can represent the style of the image; (x−μ(x))/σ(x) represents the normalization (de-stylizing) of the mean value and standard deviation of the third image feature; and, σ(y) ((x−μ(x))/σ(x))+μ(y) represents the reverse normalization of the image feature into the mean value and standard deviation corresponding to the restoration style information (stylizing according to the restoration style information). Further, features corresponding to the associated attribute are selected and extracted from the fourth image feature with the enhanced associated attribute. It is not hard to understand that the selected and extracted features are sensitive to the user attribute, and the values of these features will correspondingly change with different user attributes.

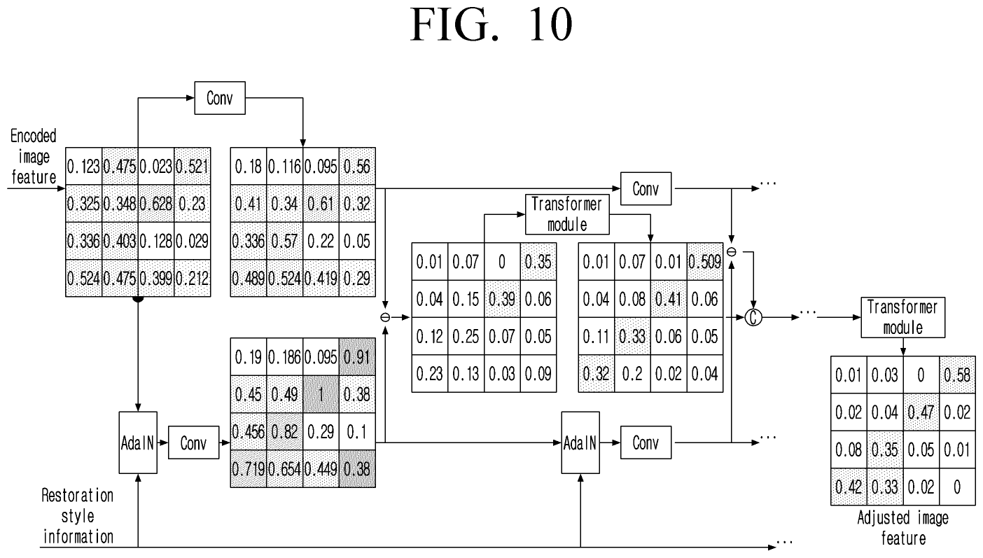

FIG. 10 is a schematic diagram of attribute feature enhancement data according to an embodiment of the disclosure.

Referring to FIG. 10, there is a difference between upper and lower branches. The upper branch is the result of further convolution of the image feature itself (the third image feature), and the lower branch is the result of further hybrid convolution of the image feature and the attribute code (the fourth image feature) (because of the combination with the style control code, the feature related to the associated attribute is highlighted through further feature extraction). Therefore, the difference between the two branches represents the texture feature related to the associated attribute. In brief, the related attribute feature is selected.

Optionally, the operation may specifically include: determining a differential image feature between the third image feature and the fourth image feature, and, adjusting the differential image feature to be consistent with the attribute information to obtain a fifth image feature.

For example, in the embodiment of the disclosure, the feature corresponding to the associated attribute selected and extracted from the fourth image feature with the enhanced associated attribute may be represented by determining the differential image feature between the third image feature and the fourth image feature.

Further, the selected and extracted feature (the determined differential image feature) may be further adjusted. In other words, this feature needs to be consistent with the guided attribute. For example, 30 years old and 70 years old are different in the expression of winkles.

Optionally, as shown in FIGS. 9 and 10, the value of the selected and extracted feature (the determined differential image feature) is adjusted to match the related attribute value by using a transformer network (module). The transformer network is used to explore the long-distance semantics of the attribute features through the overall global region, that is, the distant features in the first image can be associated. The correlation of texture features related to the associated attribute is increased, while the correlation of irrelevant texture features is decreased. For example, by taking the first image being a human face image as an example, for the feature matched with age, the feature value of this feature is adjusted according the predicted user's age. If the predicted user is old, tiny wrinkles may be emphasized.

Optionally, the differential image feature may be adjusted to correspond to the attribute information by using a plurality of transformer networks (four transformer networks are taken as an example in FIG. 9). Starting from the second transformer network, the input differential image feature may be a differential image feature between the third image feature convolved for a corresponding number of times and the fourth image feature obtained by introducing the restoration style information into the third image feature for a corresponding number of times, and the differential image feature is corrected based on the adjustment result output by the previous transformer network and then input into the current transformer network, until the last transformer network outputs the adjusted fifth image feature.

It is to be noted that, the numerical values in the image features shown in FIG. 10 are merely illustrative, and the specific numerical values are subject to practical implementations. The examples of the numerical values in FIG. 10 should not be construed as limitations to the disclosure.

In the embodiment of the disclosure, an optional implementation is provided. Specifically, this optional implementation may include the following operations:

In an embodiment of the disclosure an image feature correction amount corresponding to the attribute information is determined according to the correlation between the third image feature and the fifth image feature.

In an embodiment of the disclosure the third image feature is corrected according to the image feature correction amount to obtain the restored image.

For example, in the embodiment of the disclosure, the third image feature is modulated based on the extracted modulation information (the fifth image feature). Specifically, the decoded third image feature is corrected by using a correction module (see FIG. 8). For example, the image feature correction amount of the associated attribute is calculated and then added to the decoded feature of the third image feature to perform a modulation process to obtain the restored image.

This is because the third image feature itself contains the attribute feature. By directly superposing the modulation information (the fifth image feature, related to the associated attribute) on the decoded third image feature for image restoration, excessive texture restoration may be caused, that is, it is impossible to control the reasonable restoration of the associated texture. Therefore, the embodiment of the disclosure proposes to use a correction module to calculate the image feature correction amount corresponding to the associated attribute feature according to the existing features in the current third image feature and the modulation information, and correct the image feature corresponding to the attribute information in the third image feature according to the image feature correction amount. Specifically, the correction module functions to correct the derivation of the restored feature in guiding attributes.

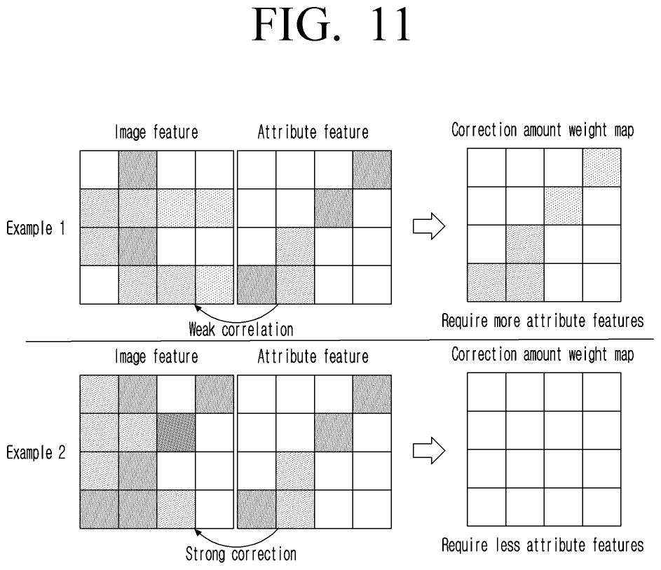

FIG. 11 is a schematic diagram of a correction amount weight map according to an embodiment of the disclosure.

Referring to FIG. 11, optionally, the correction process may be realized by calculating the correction amount weight map. Since the adjusted attribute feature (the fifth image feature) only contains the feature related to the attribute, the third image feature reflects the comprehensive feature of the first image. By using the correlation between two inputs, it can be revealed how many additional attribute features are needed in the current image feature. The higher the correction is, the less the attribute features are needed; and, the lower the correction is, the more the attributed features are needed. In the embodiment of the disclosure, this correlation is shown as a correction amount weight map which reflects the size of the correlation and also indicates the attribute feature correction amount in the current image feature.

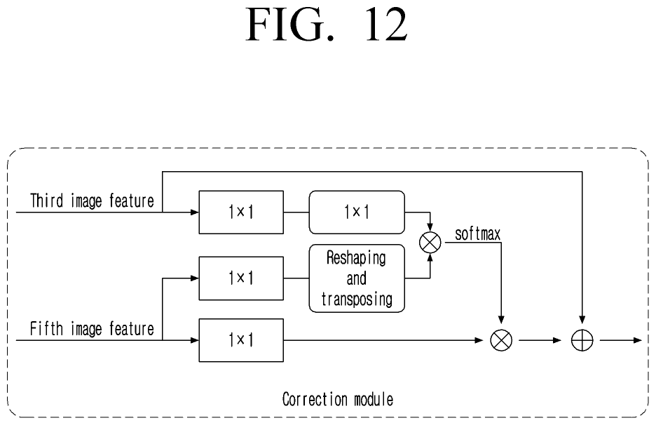

FIG. 12 is a schematic diagram of a correction module according to an embodiment of the disclosure.

Referring to FIG. 12, the result of the convolution and reshaping of the third image feature and the result of the convolution, reshaping and transposing of the fifth image feature are fused (multiplication between matrices) and then processed by an activation function (e.g., softmax, but not limited thereto) to obtain a correction amount weight map, the correction amount weight map is then convolved and fused (multiplication between matrices) with the fifth image feature to extract an appropriate image feature correction amount from the fifth image feature, and the image feature correction amount is finally added with the third image feature to obtain the result of correction of the third image feature.

If the third image feature includes at least one dimension, including: for the third image feature of each dimension, determining, according to the correlation between the third image feather of this dimension and the fifth image feature of the corresponding dimension, an image feature correction amount of this dimension corresponding to the attribute information.

Further, the operation may specifically include correcting, according to the image feature correction amount of the at least dimension, the corresponding third image feature to obtain the restored image.

The third image feature of each dimension starting from the second dimension in the at least one dimension is the third image feature obtained after correcting the image feature correction amount of the previous dimension.

For example, in the embodiment of the disclosure, the correction module may correct the third image feature of a different dimension in the decoding process, thereby realizing the reasonable restoration of the attribute related texture in each resolution dimension and finally obtaining the restored human face image.

As shown in FIG. 8, the correction module operates on each dimension feature of the decoder. The correction amount of each dimension feature may be calculated in a progressive manner. The number (N) of correction modules is related to the number (M) of decoder dimensions, and N=M. The correction in different dimension is helpful to improve the stability of texture restoration.

The correction module provided in the embodiment of the disclosure has the following advantages.

1) A feasible solution to embed the attribute (e.g., the age, gender or other attributes of the character of the human face image) into the image feature is provided.

2) The feature related to the attribute is enhanced by using the local feature extraction capability of the convolution and the remote semantic capture capability of the transformer.

3) From the deep semantic feature to the shallow texture feature, the feature related to the attribute (e.g., the character attribute of the human face image) is gradually restored by a progressive correction strategy.

Based on at least one of the above embodiments of the disclosure, an embodiment of the disclosure shows a complete process instance of personalized human face restoration by taking the first image being a human face image to be redrawn as an example.

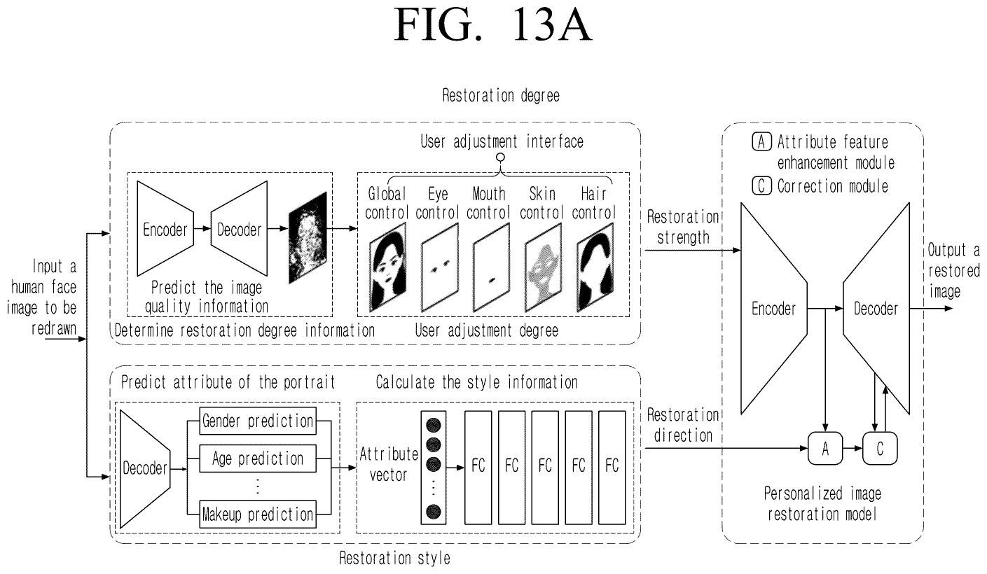

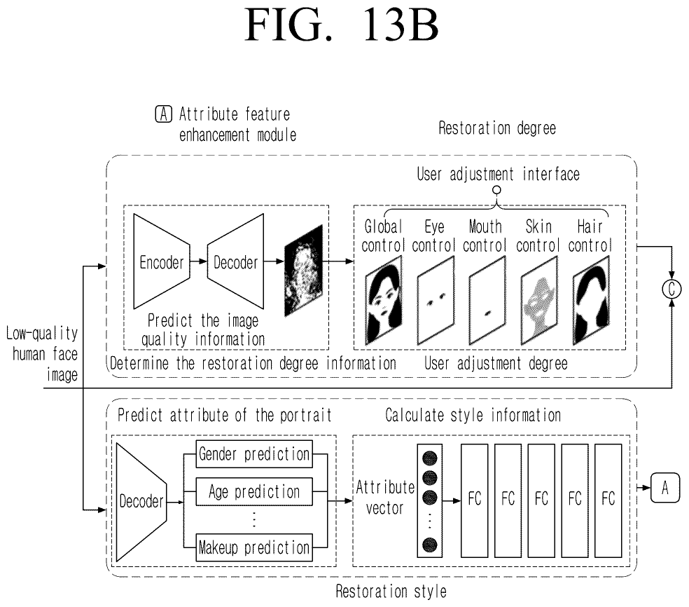

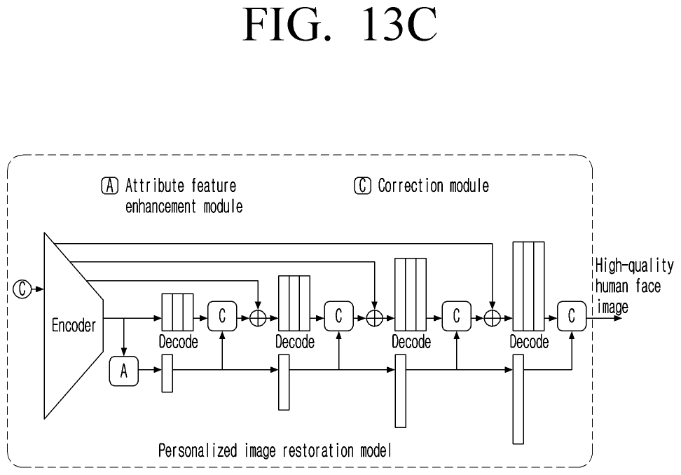

FIG. 13A is a schematic diagram of a personalized human face restoration method according to an embodiment of the disclosure.

Referring to FIG. 13A, the following operations may be included specifically.

A low-quality human face image is input into a module for determining the restoration degree information and a module for determining the restoration style information, respectively. Wherein:

In the module for determining the restoration degree information, the human face image will be processed by an encoder and a decoder to predict the image quality information of the human face image. The image quality information is used for determining the restoration degree information recommended to the user. A higher image quality means that the image is clearer and has richer texture details and fewer noise points. On the contrary, a lower image quality means that the image is more blurred and has lost texture details and more noise points. A high-quality image requires lower restoration strength, while a low-quality image requires higher restoration strength. Further, an initial restoration degree control value (restoration degree information) is recommended to a user according to the predicted image quality information and displayed in a user adjustment interface. Different users adjust the image restoration degree control value according to their preference. The user's control of the restoration degree information includes global control, and local control, such as eye control, mouth control, skin control and hair control. The user's image restoration degree control map (the adjusted restoration degree information) is obtained according to the restoration degree control value fed back by the user.

In the module for determining the restoration style information, the human face image is processed a decoder to predict various attributes of the person, for example, age prediction, gender prediction, makeup prediction, or the like, but not limited thereto. The personalized feature is closely related to the person's attribute. The plurality of predicted attributes are jointly encoded into an attribute vector, and the attribute vector is then mapped into an attribute control code by a multilayer perceptron (a plurality of FC layers) to obtain the restoration style information. The restoration style information is used for providing a restoration direction for the personalized human face redrawing model to restore the personalized feature consistent with the person's attribute.

Further, the obtained restoration degree information and restoration style information are input into the personalized human face redrawing model, so that the model is guided to use an appropriate restoration strength and restore the image in a correct restoration direction (a direct consistent with the attribute). Specifically, a deep feature code (third image feature) is extracted from the restoration degree information by the encoder. The modulation information (fifth image feature) is extracted from the deep feature code by an attribute feature enhancement module using the restoration style information. By a correction module, the decoded feature obtained after decoding the deep feature code by the decoder is corrected by using the modulation information, and the result of correction is superposed with the deep feature ode and then decoded by the decoder to output the restored human face image.

Based on at least one of the above embodiments of the disclosure, an embodiment of the disclosure shows another complete process instance of personalized human face restoration by taking the first image being a human face image as an example.

FIGS. 13B and 13C are schematic diagrams of a personalized human face restoration method according to various embodiments of the disclosure.

Referring to FIGS. 13B and 13C, the following operations may be included specifically.

A low-quality human face image is input into a module for determining the restoration degree information and a module for determining the restoration style information, respectively. In the module for determining the restoration degree information, the human face image will be processed by an encoder and a decoder to predict the image quality information of the human face image. The image quality information is used for determining the restoration degree information recommended to the user, and is displayed in the user adjustment interface. The user's control of the restoration degree information includes global control, and local control, such as eye control, mouth control, skin control and hair control. Thus, the restoration degree information adjusted by the user is obtained. In the module for determining the restoration style information, the human face image is processed a decoder to predict various attributes of the human face, for example, age prediction, gender prediction, makeup prediction, or the like, but not limited thereto. The plurality of predicted attributes are jointly encoded into an attribute vector, and the attribute vector is then mapped into the restoration style information by a multilayer perceptron (a plurality of FC layers). Further, the obtained restoration degree information and restoration style information and the human face image are input into the personalized human face redrawing model, so that the model is guided to use an appropriate restoration intensity and restore the image in a correct redrawing direction (a direct consistent with the attribute) by using the restoration degree information and the restoration style information. Specifically, the restoration degree information is superposed (which can also be construed as correction) with the human face image, and a deep feature code (third image feature) of four dimensions is extracted by the encoder. The modulation information (fifth image feature) of four dimensions is extracted from the deep feature code by an attribute feature enhancement module using the restoration style information. The decoded feature of the deep feature code of the first dimension is corrected by the correction module corresponding to the first dimension using the modulation information of the first dimension; the result of correction and the deep feature code of the second dimension are superposed and then decoded, and corrected by the correction module corresponding to the second dimension using the modulation information of the second dimension. By that analogy, the correction module corresponding to the fourth dimension outputs a high-quality human face image.

In accordance with the personalized human face redrawing method provided in the embodiment of the disclosure, the input low-quality human face image can be restored into a high-quality human face image, and the restored texture details are consistent with the actual attributes of the portrait (for example, the women's lip is rose-colored; the skin of the young people is tighter and smoother than that of the elderly, or the like).

In the embodiment of the disclosure, considering that a phenomenon that the restored image is still not natural in the subjective visual perception may occur since no subjective visual perception factors are taken into consideration in the image restoration process, an optional method for optimizing the restoration degree information (e.g., the restoration degree control map) is further provided. Specifically, this method may include: repeating the following update process for at least one time.

In an embodiment of the disclosure a peak signal to noise ratio (PSNR) of the first image is determined according to the currently obtained restored image.

In an embodiment of the disclosure a restoration degree information update parameter is determined according to the peak signal to noise ratio.

In an embodiment of the disclosure the restoration degree information is updated based on the restoration degree information update parameter.

In an embodiment of the disclosure the first image is restored based on the updated restoration degree information to obtain the updated restored image.

The PSNR value is an objective evaluation index. In the embodiment of the disclosure, after one or more image restorations are performed to obtain the restored image, the restoration degree information may be optimized according to the restored image.

Specifically, the PSNR value of the first image may be determined according to the currently obtained restored image, and the restoration degree information update parameter (i.e., the image quality degree to be adjusted) may be determined according to this PSNR value:

$${q}^{\hat{}} = γ \times f ( PSNR )$$

where q\hat{ } represents the restoration degree information update parameter, γ is derived from the user's control (e.g., the output result of FIG. 6), f (PSNR) represents the image subjective perception adjustment parameter determined according to the PSNR value, and the PSNR value is remapped to [0,1].

Optionally, the image subjective perception adjustment parameter may be determined according to the PSNR value and the user's subjective perception sensitivity rule:

where PSNR is the above PSNR value, and a and b are related to the user's subjective perception sensitivity rule.

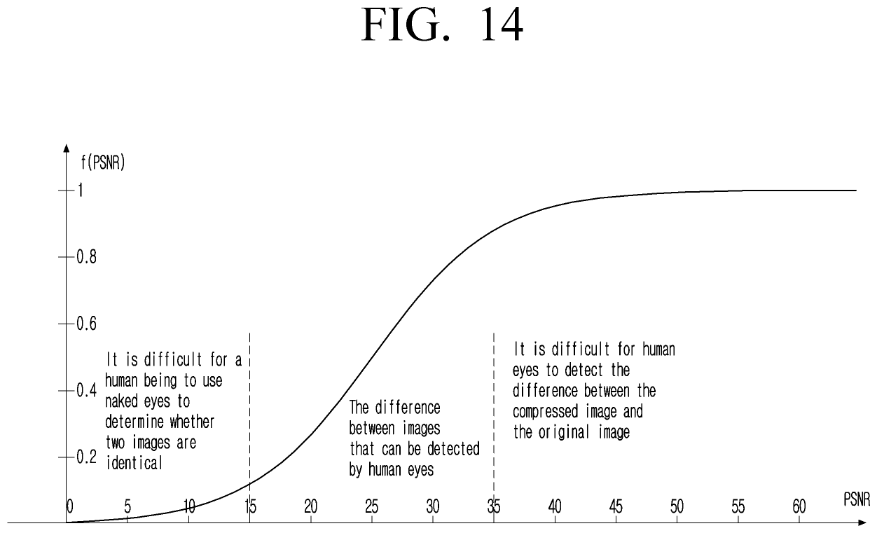

Optionally, a relation mapping function between the PSNR value and the user's subjective perception may be determined according to the rule shown in FIG. 14.

FIG. 14 is a schematic diagram of a change rule of image quality by visual perception according to an embodiment of the disclosure.

Referring to FIG. 14, specifically, when the PSNR is between 15 db and 35 db, the person's vision is sensitive to the change in the image quality. If the PSNR of the first image is within this range, the mapping function may adopt a larger change rate so that the image subjective perception adjustment parameter changes greatly. When the PSNR is less than 15 db or greater than 35 db, the person's vision is insensitive to the change in the image quality, and the mapping function may adopt a low change rate so that the image subjective perception adjustment parameter changes slightly. In the embodiment of the disclosure, a and b are used to control the steepness of the curve and determine the range of the sensitive region, and a and b may be set as a=5 and b=5 by default. The two parameters may also be adjusted according to the user's preference. For example, if the user prefers to richer details and clearer edges, the two values may be increased. The mapping function f considers the subjective perception of human vision to the PSNR, and f (PSNR) better reflects the subjective perception of human vision to the image.

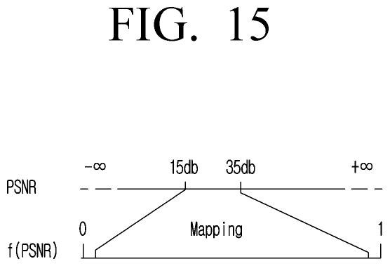

FIG. 15 is a schematic diagram of the relation mapping between the PSNR value and the user's subjective perception according to an embodiment of the disclosure.

Referring to FIG. 15, in the embodiment of the disclosure, the mapping function maps the sensitivity range of human vision to the image change into most of the new value range, so that the mapping function focuses on the subjective perception of human eyes. Thus, the subjective perception adjustment parameter may be calculated according to the mapping function.

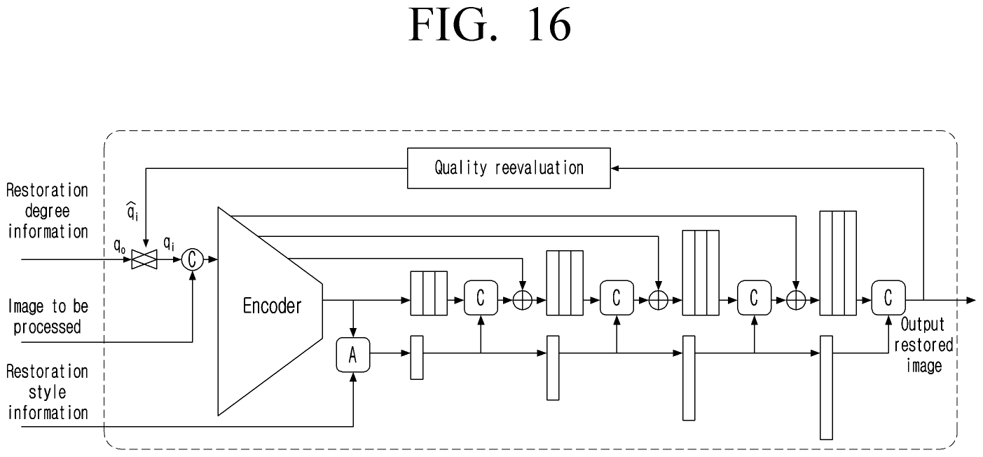

FIG. 16 is a schematic diagram of a method for optimizing restoration degree information according to an embodiment of the disclosure.

Further, referring to FIG. 16, the predicted image restoration degree information (quality map) may be iteratively updated through the self-reference quality reevaluation of the model (determining the restoration degree information update parameter). Specifically, q0 is the predicted restoration degree information. After the personalized image restoration model (see FIG. 8), the output restored image is used as a reference to reevaluate the input first image and output a piece of reevaluated restoration degree information q. After the fusion gate, the new quality map qi is used for personalized image restoration again.

What is not detailed in FIG. 16 may refer to the description of FIG. 8 and will not be repeated here.

Furthermore, the restoration degree information (for example, which may be the image restoration degree control map) is adjusted based on the restoration degree information update parameter determined by the subjective perception adjustment parameter.

In the embodiment of the disclosure, the subjective perception adjustment parameter is generated by the mapping function and reflects the restoration degree of the restored image output under the current setting. However, more considering the subjective sensitivity of human eyes, the subjective perception adjustment parameter may be weighted and fused with the historical restoration degree information to obtain new restoration degree information. The restoration degree information considers the distribution of the image quality and the user's preference for the restoration degree, and also considers the universal subjective visual perception.

Since the subjective perception of human vision is fully take into consideration, the updated image restoration degree can guide the network to restore textures more suitable for human perception. As an example, the inventor of the disclosure has conducted two rounds of experiments to reevaluate the image restoration degree information by taking an eye region of a human face image as the input. Under the guidance of the initially predicted restoration degree information q0=0.567, the strength of image restoration by the network is slightly low for the human perception; based on the restoration degree information q\hat{ }_1=0.335 of the first round of reevaluation, under the updated restoration degree information q1=0.451, the strength of image region is slightly high for the human perception; and, based on the restoration degree information q\hat{ }_2=0.545 of the second round of reevaluation, under the updated restoration degree information q1=0.498, the strength of image region is slightly high for the human perception conforms to the human perception.

In the embodiment of the disclosure, an optional implementation is provided. Specifically, this optional implement may include at least one of the following ways.

In an embodiment of the disclosure a second image is acquired.

In the embodiment of the disclosure, the first image may be derived from the second image. For example, the second image is a stored image or a shot image, or the like, and the first image is a partial region image in the second image.

In an embodiment of the disclosure a target object in the second image is determined.

For example, in the embodiment of the disclosure, the first image is related to the region where the target object is located in the second image.

In an embodiment of the disclosure the first image is determined based on at least one of the following.

### (1) The Number of the Detected Target Object

Optionally, if the second image contains only one target object, the region corresponding to this target object may be used as the first image; and, if the second image contains a plurality of target objects, the region corresponding to each target object may be used as one first image, or the region corresponding to some target objects may be used as one first image.

Optionally, when the number of the detected target object is less than a first set threshold, the region corresponding to each target object is used as one first image; and, when the number of the detected target object is not less than the first set threshold, the region corresponding to some target objects may be used as one first image, for the subsequent image restoration process. In practical applications, those skilled in the art can set the first set threshold according to the actual situation, and it will not be limited in the embodiment of the disclosure.

### (2) The Image Quality of the Image Region Corresponding to the Detected Target Object

For example, in the embodiment of the disclosure, whether the image region corresponding to one target object needs to be redrawn may be determined by using the image quality of the image region corresponding to this target object.

Optionally, the determining, based on the image quality of the image region corresponding to the detected target object, a first image in the image region corresponding to the target object may include: determining the image quality of the image region corresponding to at least one target object; and, determining an image region having an image quality correlation value less than a second set threshold as the first image. If the image quality correlation value is less than a second set value, the corresponding image region is used as one first image, and the subsequent image restoration process may be activated. This setting can save calculation resources and improves the real-time processing performance. In practical applications, those skilled in the art can set the value (e.g., 90, or the like) of the second set threshold according to the actual situation, and it will not be limited in the embodiment of the disclosure.

Optionally, there are various determination criteria for the image quality correlation value. For example, the clarity of the image region may be checked as the initial quick determination criterion by using the signal processing technology. Other determination criteria may also be used, and it will not be limited in the embodiment of the disclosure.

### (3) Target Object Selection Instruction Input by the User

In the embodiment of the disclosure, for the image region corresponding to one or more target objects included in the second image, it may be determined by the user whether the image region corresponding to each target object is used as the first image to execute the subsequent image restoration process; or, the image region corresponding to one or more target objects may be selected by the user as the first image to execute the subsequent image restoration process. If the user selects the image region corresponding to one target object, the image region corresponding to this target object is used as the first image; and, if the user selects the image regions corresponding to a plurality of target objects, the image region corresponding to each target object selected by the user is used as one first image, respectively.

It should be understood that the above ways may be combined according to the setting to determine the first image.

As an example, in one optional implementation, the way of determining the first image may include: when the number of the detected target object is not less than the first set threshold, determining, based on at least one of the image quality of the image region corresponding to the detected target object and the target object selection instruction input by the user, a first image in the image region corresponding to the target object.

For example, when the number of the detected target object is not less than the first set threshold, it may be determined, according to the image quality of the image region corresponding to each target object, which image region is determined as the first image for processing.

Alternatively, when the number of the detected target object is not less than the first set threshold, the user may select the image region corresponding to which target object as the first image for processing.

In practical applications, those skilled in the art can set the combination mode of the above ways according to the actual situation, and it will not be limited in the embodiment of the disclosure.

Optionally, for an image region that is not used as the first image to execute the subsequent image restoration process, when the user does not use the electronic device, or in the set period of time, or in the set device state, the image region (which may be unprocessed) corresponding to each target object may be automatically used as the first image to execute the subsequent image restoration process.

In the embodiment of the disclosure, a feasible implementation is provided. Specifically, the acquiring a second image includes at least one of the following ways.

### (1) The Second Image is Acquired Based on the Images Acquired by an Acquisition Apparatus in Real Time.

For example, when the user takes pictures using a mobile phone or other electronic devices, the processing process of at least one of the above embodiments may be triggered. The acquisition apparatus may be built in or external to the electronic device, and it will not be limited in the embodiment of the disclosure.

Optionally, the image acquired by the acquisition apparatus in real time may be selected by the user as the second image to trigger the processing process of at least one of the above embodiments. If the user selects NO, the image may be deleted or directly stored in the electronic device based on the user's instruction.

Optionally, if the second image is an image acquired by the acquisition apparatus in real time, the method may further include: when the number of the detected target object is not less than a third set threshold, storing the second image. For example, whether to process the second image in real time is determined according to the number of the target object. For the second image that is not processed in real time, the processing process of at least one of the above embodiments may be executed offline (when the user does not use the electronic device, or in the set period of time, or in the set device state, but not limited thereto) or in the back end. Optionally, in the case of non-real-time processing, which image region may be determined offline or in the back end as the first image for processing according to the image quality of the image region corresponding to each target object. Or, the user may select offline or in the back end whether to use the image region corresponding to the target object as the first image for processing, or the user may select to use the image region corresponding to which target object(s) as the first image for processing.

Optionally, each acquired image that is stored directly may be subsequently used as the second image to trigger the processing process of at least one of the above embodiments. For example, each image that is stored directly may be automatically processed offline or in the back end. For example, each stored image may be processed to obtain a high-quality restored image.

Optionally, in addition to the processing process of at least one of the above embodiments of the disclosure, a remaster function may also be triggered. The remaster function includes, but not limited to, denoising, color processing, blurring, image restoration in at least one of the above embodiments of the disclosure, or other image processing functions.

### (2) The Second Image is Acquired Based on the Images Stored in the Electronic Device.

For example, when the user selects an image from the photo album of the electronic device, the image may be used as the second image to trigger the processing process of at least one of the above embodiments.

Optionally, each stored image may be used as the second image to trigger the processing process of at least one of the above embodiments. For example, each image that is stored directly may be automatically processed offline or in the back end. For example, each stored image may be processed to obtain a high-quality restored image.

Optionally, in addition to the processing process of at least one of the above embodiments of the disclosure, the remaster function may also be triggered.

Further, the method may further include the following operations of determining a corresponding third image based on the restored image and the second image, and, storing or displaying the third image.

For example, the picture shot by the user is redrawn and stored in the photo album of the electronic device.

For another example, the picture selected from the photo album by the user is redrawn and displayed in the interface of the electronic device.

For still another example, the picture in the photo album is redrawn in the back end and then stored in the photo album of the electronic device.

In practical applications, those skilled in the art can set the storage or display occasion according to the actual situation, and it will not be limited in the embodiment of the disclosure.

In the embodiment of the disclosure, the corresponding third image is determined based on the restored image and the second image. For example, the image region corresponding to the target object in the second image is used as the first image for restoration to obtain the restored image, and the restored image is fused with the second image to obtain the third image with the redrawn target object.

In the embodiment of the disclosure, the way of fusing the restored image and the second image will not be limited specifically. As an example, a binary mask image of the first image is acquired. In the binary mask image, 1 represents the first image region, 0 represents the background region, the pixel value of the region with a mask value of 0 remains unchanged, and the pixel value of the region with a mask value of 1 may adopt the updated pixel value (corresponding to the restored image). A filter band may be set at the junction of 0 and 1 (i.e., at the edge of the first image), and the mask value in the filter band may be 0 to 1 to achieve a seamless fusion effect. Optionally, for the pixels in the filter band, the mask weight may be determined according to the semantics of the pixels, thereby achieving a finer seamless fusion effect. In practical applications, other restored image fusion methods, such as Poisson image fusion technology can also be used, and it will not be limited in the embodiment of the disclosure.

Based on at least one of the above embodiments of the disclosure, some process examples of personalized human face redrawing are provided.

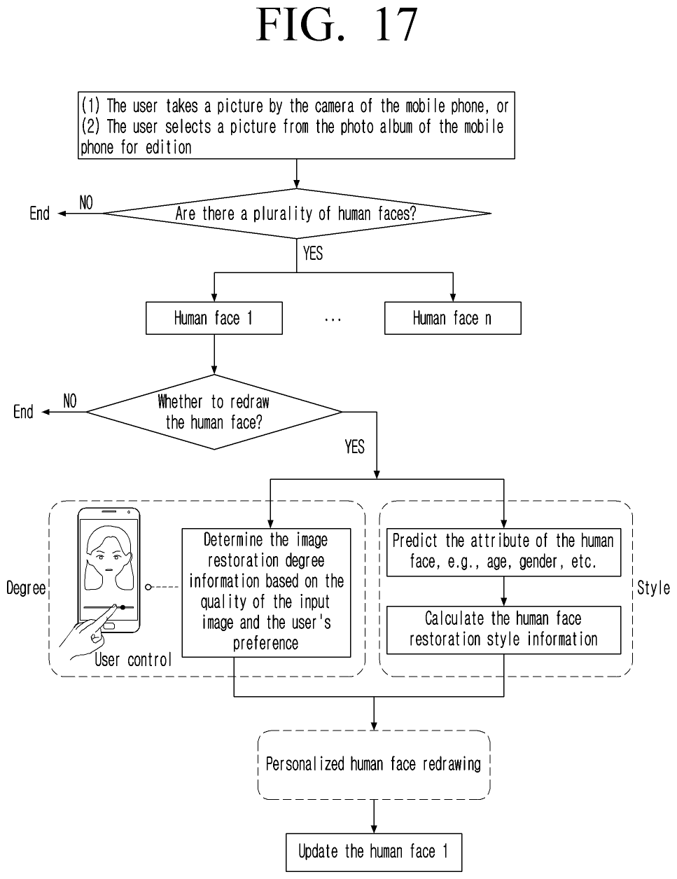

FIG. 17 is a schematic diagram of a personalized human face redrawing method according to an embodiment of the disclosure.

Referring to FIG. 17, a process example of personalized human face redrawing is shown. Specifically, the following operations may be included.

In operation 17.1, the user takes a picture using the camera of the mobile phone or selects a picture from the album of the mobile phone for edition to obtain an image (second image).

In operation 17.2, human face (target object) recognition is performed to determine whether the image is a human face image with at least one human face (determining the number of the target object). If not, the process ends; and if so, the process proceeds to the next operation.

In operation 17.3, the human face in the human face image is split into individual human face regions.

In operation 17.4, for at least one human face region (first image), the user is queried whether human face redrawing is required. If the user selects NO, the process ends; and, if the user selects YES (the target object selection instruction input by the user), operations 17.5 and 17.7 will be executed.

In operation 17.6, an image restoration degree adjustment (confirmation) interface is provided.

In operation 17.6, the restoration degree information input by the user through the adjustment interface is received, and the image restoration degree information is determined according to the image quality information of the human face region and/or the user's preference, to guide the restoration strength required by human face redrawing.

In operation 17.7, the human face attribute information (e.g., age, gender, makeup and other attribute information) corresponding to the human face region is predicted.

In operation 17.8, the restoration style information is determined based on the human face attribute information to guide the restoration direction required by personalized human face redrawing.

In operation 17.9, the human face region is restored based on the restoration degree information obtained in the operation 17.6 and the restoration style information obtained in the operation 17.8 by using an AI network, to realize personalized human face redrawing.

In operation 17.10, the updated human face region is output.

For the individual human face regions shown in the operation 17.3, generally, the maximum number n (the first set threshold) of human faces that can be processed may be determined according to the calculation capability of the electronic device. If the number of human faces in the image is greater than n, which human faces may be determined for processing by the following possible solutions.

Solution 1: It is selected by the user. For example, a selectable interface is provided for the user to click or circle.

Solution 2: it may be automatically selected by the learnt neural network model according to the state of the human face in the picture.

For the activation condition of human face redrawing shown in the operation 17.4, it may be determined according to the initial image quality measurement criteria (the image quality of the image region corresponding to the target object) whether to redraw the human face. One possible solution is to score by measuring the clarity of the face by a signal processing method. This strategy is helpful to save the calculation resources and improve the real-time performance.

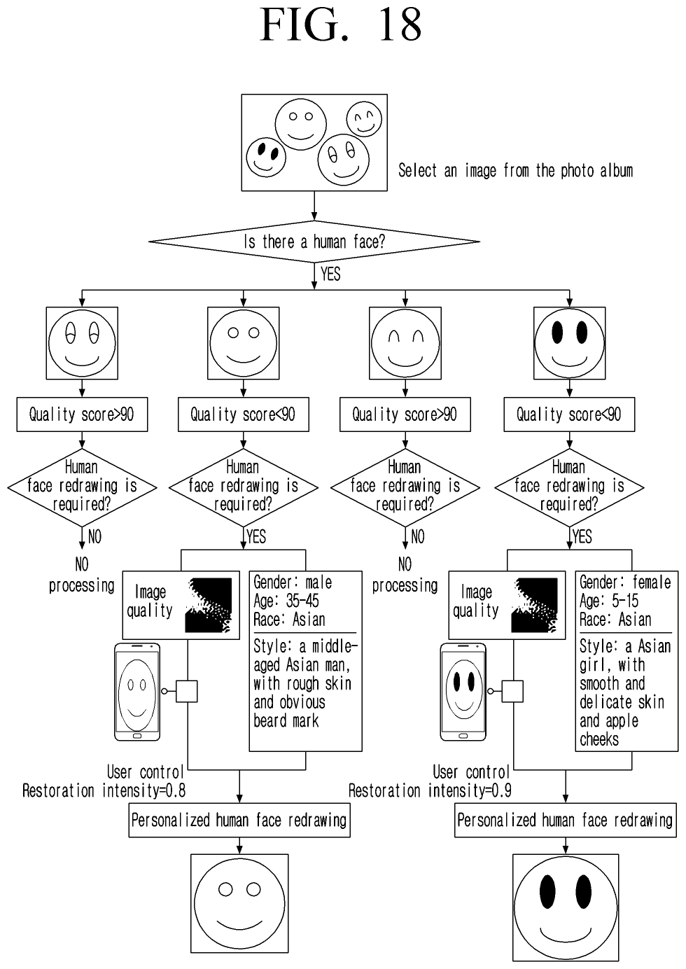

FIG. 18 is a schematic diagram of a personalized human face redrawing method according to an embodiment of the disclosure.

Referring to FIG. 18, another process example of personalized human face redrawing is shown. Specifically, the following operation may be included.

In operation 18.1, an image (second image) is selected from the photo album of the mobile phone for edition.

In operation 18.2, human face recognition is performed to determine whether there is at least one human face in the image (determining the number of the target object); and if so, the process proceeds to the next operation.

In operation 18.3, the human face in the image is split into individual human face regions.

In operation 18.4, for each human face region (first image), an image quality score (image quality correlation value) is detected to determine whether to redraw the human face. If the quality score is greater than 90 (second set threshold), no processing is performed; and, if the quality score is less than 90, human face redrawing is activated, and operations 18.5 and 18.7 will be executed.

In operation 18.5, the image quality of the human face region requiring human face redrawing is determined.

In operation 18.6, the restoration degree information of user control is received, and the image restoration degree information (restoration intensity) is determined based on the quality information of the human face region and the user control result.

In operation 18.7, the human face attribute information (e.g., age, gender, or the like) corresponding to the human face region is predicted.

In operation 18.8, the restoration style information is determined based on the human face attribute information.

In operation 18.9, the human face region is restored based on the restoration degree information obtained in the operation 18.6 and the restoration style information obtained in the operation 18.8 by using an AI network, to realize personalized human face redrawing.

In operation 18.10, the updated human face region is output.

Optionally, the personalized human face redrawing process provided in the embodiment of the disclosure may be applied to the photo album image edition scheme, and determining whether to redraw the human face based on the image quality measurement criteria is used as the activation condition for use in the photo album.

For the human face redrawing effects of the embodiment of the disclosure, the image quality after image drawing is obviously improved compared with that before redrawing, and each person in the image is clear.

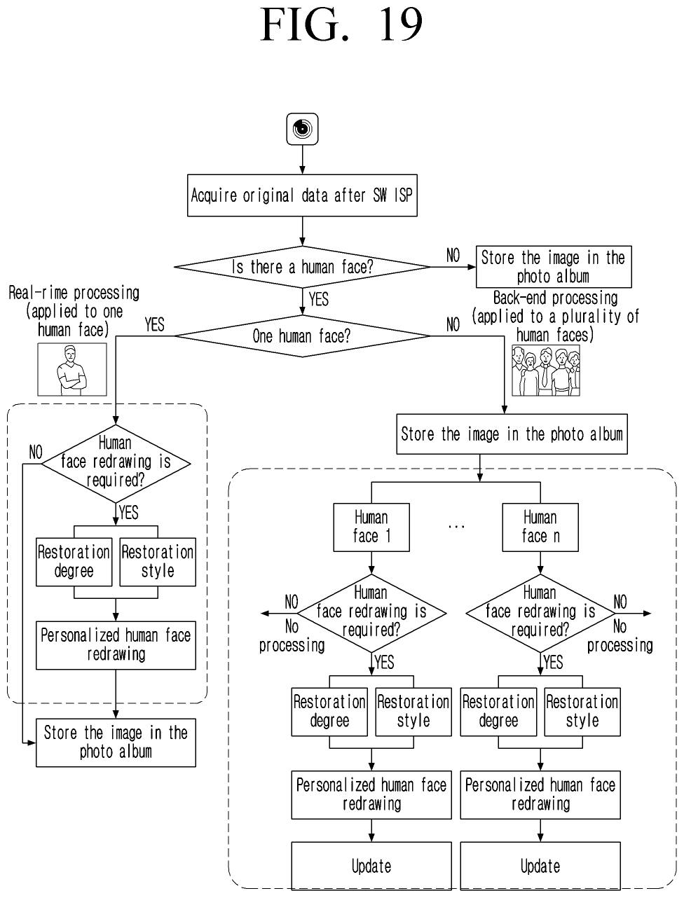

FIG. 19 is a schematic diagram of still another personalized human face redrawing method according to an embodiment of the disclosure.

Referring to FIG. 19, still another process example of personalized human face redrawing is shown. Specifically, the following operations may be included.

In operation 19.1, a picture is shot by the mobile phone, and original data (second image) is acquired before the image signal processing (ISP) software (SW).

In operation 19.2, human face recognition is performed to determine whether there is a human face in the image (determining the number of the target object); if so, the process proceeds to the next operation; and if not, the image is stored in the photo album.

In operation 19.3, it is determined whether there is one (third set threshold, which may be considered as the first set threshold) human face in the image (determining the number of the target object), if so, operation 19.4 will be executed (real-time processing, applied to one human face); and if not, the image is stored in the photo album, and operation 19.8 will be executed (back-end processing, applied to a plurality of human faces).

In operation 19.4, it is determined whether to redraw the human face (the target object selection instruction input by the user or the image quality of the image region corresponding to the detected target object). If not, the image is stored in the photo album; and if so, human face (first image) redrawing is activated, and the next operation will be executed.

In operation 19.5, the restoration degree information and restoration style information of the human face image are determined.

In operation 19.6, the human face region is restored based on the restoration degree information and the restoration style information by using an AI network, to realize personalized human face redrawing.

In operation 19.7, the redrawn human face image is stored in the photo album.

In operation 19.8, it is determined whether to perform human face redrawing for each human face (first image) in the image. If not, no processing is performed; and if so, human face redrawing is activated, and the next operation will be executed.

In operation 19.9, the restoration degree information and restoration style information of the human face image are determined.

In operation 19.10, the human face region is restored based on the restoration degree information and the restoration style information by using an AI network, to realize personalized human face redrawing.

In operation 19.11, the redrawn human face image is updated to the photo album.

Optionally, the personalized human face redrawing process provided in the embodiment of the disclosure may be applied to the camera shooting scheme, and determining whether to redraw the human face based on the user selection and/or the image quality measurement criteria is used as the activation condition for use in the camera.

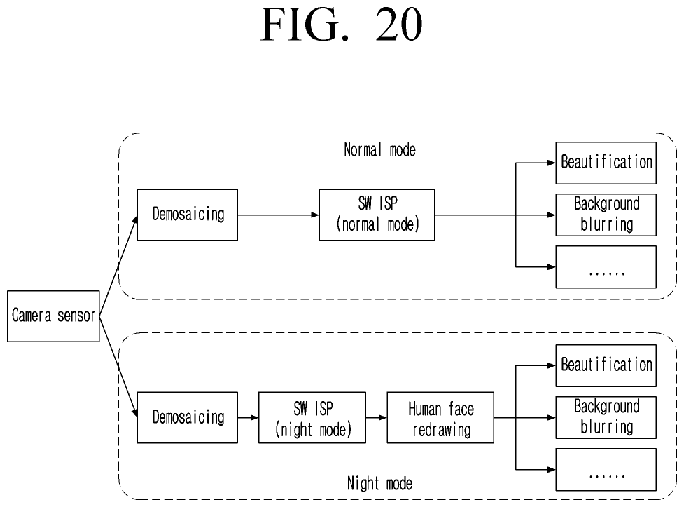

FIG. 20 is a schematic diagram of a typical camera pipeline of an AI camera according to an embodiment of the disclosure.

Referring to FIG. 20, it should be emphasized that the human face redrawing technology provided in at least one of the above embodiments is to restore the real and natural human face details, and objectives factors are dominant. Instead of changing the features of the human face to improve the visual effect (for example, by changing the shape of the human face to achieve the “big eyes” or “thin face” effect, or using a simple filter to make the skin smoother), high-frequency detail information is generated by interpolation in the existing texture prior information, including learning a large number of high-definition face prior knowledge to generate semantically reasonable and real natural texture details in the texture-free region. In the camera pipeline, human face redrawing is located at the front position. To sum up, the human face redrawing technology provided in the embodiment of the disclosure is to generate real features, instead of changing real features. The typical camera pipeline of the AI camera may be shown in FIG. 20, and may be in a normal mode and a night mode. In the normal mode, the image output by the camera sensor is subjected to demosaicing and then processed by the ISP software in the normal mode, and may be subsequently subjected to beautification, background blurring or other processing. Optionally, the technical solutions in the embodiment of the disclosure may be applied in the night mode. In the night mode, the image output by the camera sensor is subjected to demosaicing and then processed by the ISP software in the night mode, and may be subjected to human face redrawing provided in the solutions of the embodiments of the disclosure, and subsequently subjected to beautification, background blurring or other processing. It can be seen that, in the camera pipeline, human face redrawing is located at the front position. In practical applications, the technical solutions in the embodiment of the disclosure can also be applied to other modes except for the night mode, and it will not be limited in the embodiment of the disclosure.

Compared with the related art, the personalized human face redrawing scheme provided in the embodiment of the disclosure can generate natural and real texture and realize real image redrawing. For example, for an image that is shot under low light conditions, the image quality can still be ensured.

Compared with the related art, the personalized human face redrawing scheme provided in the embodiment of the disclosure can restore personalized face features consistent with the user's attributes, for example, the red lip of women (gender attribute), the skin of young people being tighter and smother (age attribute) than that of the elder, or the like.

Compared with the related art, the personalized human face redrawing scheme provided in the embodiment of the disclosure can adopt different restoration intensity in different regions by using the restoration degree information when different regions in the image have different image qualities. The image restoration degree refers to the image restoration intensity. A high restoration degree means that the restored image is clearer and has richer texture details. A low restoration degree means that the restored image has much texture loss and noise points and is blurred. The image restoration degree includes the global restoration degree and the local restoration degree. The local restoration degree means the restoration degree of the local region, for example, the restoration degree of the eye region, the eyebrow region or the mouth region.

Compared with the related art, the personalized human face redrawing scheme provided in the embodiment of the disclosure predicts the image quality information (see FIG. 5A) by using the depth information and the lightness information, directly reflects the image restoration degree and can predict the restoration degree more accurately.

Compared with the related art, in the personalized human face redrawing scheme provided in the embodiment of the disclosure, the restoration style information is used for extracting the deep image feature corresponding to the given attribute of the character to serve the modulation information (see FIG. 9), and the restoration style information can be more accurately used for guiding the restoration direction.

Compared with the related art, in the personalized human face redrawing scheme provided in the embodiment of the disclosure, image features of different dimensions in the decoding process are adaptively corrected (see FIG. 12) based on the modulation information to obtain the restored human face image, so that more realistic and reasonable textures can be generated.

The personalized human face redrawing scheme provided in the embodiment of the disclosure can be applied in the photographing mode of the mobile phone. When the user takes a picture by the photographing function of the mobile phone, the camera of the mobile phone will detect the character in the picture by itself and performs personalized quality enhancement on the human face region. The personalized human face redrawing scheme can also be applied in the image edition function of the photo album. When the edited contains a human face, this scheme is activated, and personalized quality enhancement is performed on the human face region.

The technical solutions provided in the embodiments of the disclosure can be applied to various electronic devices, including but not limited to, mobile terminals, intelligent terminals, or the like, for example, smart phones, flat computers, notebook computers, intelligent wearable devices (e.g., watches, glasses, or the like), smart speakers, vehicle-mounted terminals, personal digital assistants, portable multimedia players, navigation apparatuses, but not limited thereto. It should be understood by those skilled in the art that, except for the elements special for mobile purpose, the configurations according to the embodiments of the disclosure can also be applied to a fixed type of terminals, such as digital television (TV) sets or desktop computers.

The technical solutions provided in the embodiments of the disclosure can also be applied to image restoration in servers, such as separate physical servers, which may be server clusters or distributed systems including multiple physical servers, or may be cloud servers that provide basic cloud computing services, such as cloud services, cloud databases, cloud computing, cloud functions, cloud storage, network services, cloud communication, middleware services, domain name services, security services, content delivery networks (CDNs) and big data and artificial intelligent platforms.

By taking a smart phone as an example, the camera function of the smart phone is an important selling point of the smart phone and has become one of the core competence of major brands of smart phones. With the popularization and the increasing frequency of alternation of smart phones, the camera function of mobile phones is more and more powerful, and the AI-based image quality improvement technology has greatly improved the imaging quality of mobile phone cameras.

In addition, users also have higher and higher requirements for the imaging quality of cameras. In addition to the imaging quality, users also expect that the portraits in pictures are more personalized and can reflect the characteristics consistent with the attributes of the characters in the pictures, for example, women's rosy lip and compact skin.

The technical solutions provided in the embodiments of the disclosure can meet such requirements and realize the introduction of more personalized features into the mobile phone cameras.

In some examples, the visual effects achieved by the technical solutions provided in the embodiments of the disclosure may include, but not limited to, the following: the pores of the character's skin are restored to better conform to the real gender; the wrinkled skin of the character are restored to conform to the real age of the human being; more reasonable textures of the character are restored without artifacts; the user can globally control the restoration degree by adjusting the global control variable α, for example, setting α=0.5, α=0.8, or the like, so that the output images of different restoration degrees can be obtained; and, the user can locally control the restoration degree of the eyes by adjusting the local control variable β1, for example, setting β1=0.4, β1=0.9, or the like, so that the output image of different eye restoration degrees can be obtained.

An embodiment of the disclosure further provides an electronic device, comprising a processor, and optionally a transceiver and/or memory coupled to the processor, wherein the processor is configured to execute the operations of the method according to any one of the optional embodiments of the disclosure.

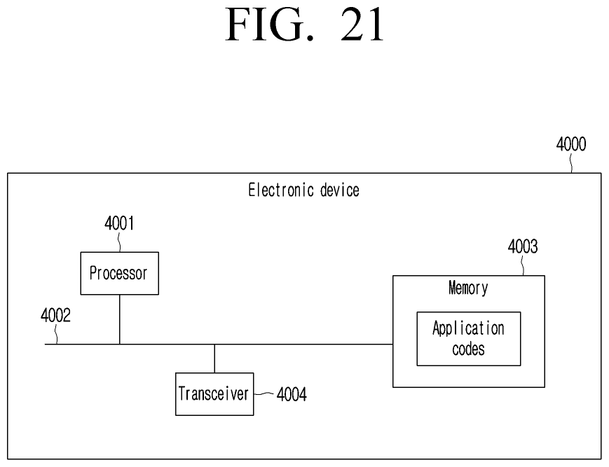

FIG. 21 shows a schematic structure diagram of an electronic device according to an embodiment of the disclosure.

Referring to FIG. 21, an electronic device 4000 shown in FIG. 21 may include a processor 4001 and memory 4003. The processor 4001 is connected to the memory 4003, for example, through a bus 4002. Optionally, the electronic device 4000 may further include a transceiver 4004, and the transceiver 4004 may be used for data interaction between the electronic device and other electronic devices, such as data transmission and/or data reception. It should be noted that, in practical applications, the transceiver 4004 is not limited to one, and the structure of the electronic device 4000 does not constitute a limitation to the embodiments of the disclosure. Optionally, the electronic device may be a first network node, a second network node or a third network node.

The processor 4001 may be a central processing unit (CPU), a general-purpose processor, a digital signal processor (DSP), an application specific integrated circuit (ASIC), a field programmable gate array (FPGA) or other programmable logic devices, transistor logic devices, hardware components, or any combination thereof. It may implement or execute the various logical blocks, modules and circuits described in connection with this disclosure. The processor 4001 can also be a combination that implements computing functions, such as a combination of one or more microprocessors, a combination of a DSP and a microprocessor, and the like.

The bus 4002 may include a path to transfer information between the components described above. The bus 4002 may be a peripheral component interconnect (PCI) bus or an extended industry standard architecture (EISA) bus or the like. The bus 4002 can be divided into an address bus, a data bus, a control bus, and the like. For ease of representation, only one thick line is shown in FIG. 21, but it does not mean that there is only one bus or one type of bus.

The memory 4003 may be read only memory (ROM) or other types of static storage devices that can store static information and instructions, random access memory (RAM) or other types of dynamic storage devices that can store information and instructions, and can also be electrically erasable programmable read only memory (EEPROM), compact disc read only memory (CD-ROM) or other optical disk storage, compact disk storage (including compressed compact disc, laser disc, compact disc, digital versatile disc, blue-ray disc, or the like), magnetic disk storage media, other magnetic storage devices, or any other medium capable of carrying or storing computer programs and capable of being read by a computer, without limitation.

The memory 4003 is used for storing computer programs for executing the embodiments of the disclosure, and the execution is controlled by the processor 4001. The processor 2401 is configured to execute the computer programs stored in the memory 4003 to implement the operations shown in the foregoing method embodiments.

Embodiments of the disclosure provide one or more non-transitory computer-readable storage media having a computer program stored on the computer-readable storage medium, the computer program, when executed by a processor, implements the operations and corresponding contents of the foregoing method embodiments.

Embodiments of the disclosure also provide a computer program product including a computer program, the computer program when executed by a processor realizing the operations and corresponding contents of the preceding method embodiments.

The terms “first”, “second”, “third”, “fourth”, “1”, “2”, or the like (if present) in the specification and claims of this disclosure and the accompanying drawings above are used to distinguish similar objects and need not be used to describe a particular order or sequence. It should be understood that the data so used is interchangeable where appropriate so that embodiments of the disclosure described herein can be implemented in an order other than that illustrated or described in the text.

It should be understood that while the flow diagrams of embodiments of the disclosure indicate the individual operations by arrows, the order in which these operations are performed is not limited to the order indicated by the arrows. Unless explicitly stated herein, in some implementation scenarios of embodiments of the disclosure, the implementation operations in the respective flowcharts may be performed in other orders as desired. In addition, some, or all of the operations in each flowchart may include multiple sub-operations or multiple phases based on the actual implementation scenario. Some or all of these sub-operations or stages can be executed at the same moment, and each of these sub-operations or stages can also be executed at different moments separately. The order of execution of these sub-operations or stages can be flexibly configured according to requirements in different scenarios of execution time, and the embodiments of the disclosure are not limited thereto.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device, the method comprising:
acquiring a first image;
determining restoration style information of the first image; and
restoring the first image based on the restoration style information by using an artificial intelligence (AI) network to obtain a restored image.

2. The method of claim 1, wherein the restoration style information is related to attribute information of a target object in the first image.

3. The method of claim 1, further comprising:
determining restoration degree information of the first image,
wherein the restoring of the first image based on the restoration style information by using an AI network comprises:
restoring the first image based on the restoration style information and the restoration degree information by using an AI network.

4. The method of claim 3, wherein the restoration degree information is related to at least one of:
image quality of the first image; or
a restoration degree related instruction input by a user.

5. The method of claim 3, wherein the determining of the restoration degree information of the first image comprises:
providing a restoration degree confirmation interface for the first image; and
in response to a restoration degree related instruction input by a user through the restoration degree confirmation interface, determining second restoration degree information of the first image.

6. The method of claim 5,
wherein the providing of the restoration degree confirmation interface for the first image comprises:
determining image quality information of the first image,
determining corresponding first restoration degree information based on the image quality information, and
providing a restoration degree confirmation interface for the first image based on the first restoration degree information, and
wherein, in response to the restoration degree related instruction input by the user through the restoration degree confirmation interface, the determining of the second restoration degree information of the first image comprises:
in response to an adjustment instruction to the first restoration degree information input by the user through the restoration degree confirmation interface, determining second restoration degree information of the first image.

7. The method of claim 3, wherein the determining of the restoration degree information of the first image comprises:
determining image quality information of the first image; and
determining corresponding first restoration degree information based on the image quality information.

8. The method of claim 5, wherein the restoration degree confirmation interface comprises at least one of:
a global restoration degree confirmation interface or at least one local restoration degree confirmation interface, wherein the at least one local restoration degree confirmation interface corresponds to at least one local region of a target object.

9. The method of claim 8, wherein, in response to the restoration degree related instruction input by the user through the restoration degree confirmation interface, the determining of the second restoration degree information of the first image comprises:
determining second restoration degree information of the first image in response to at least one of:
a global restoration degree related instruction input by the user through the global restoration degree confirmation interface, or
at least one local restoration degree related instruction input by the user through the at least one local restoration degree confirmation interface.

10. The method of claim 6,
wherein the determining of the corresponding first restoration degree information based on the image quality information comprises:
determining first global restoration degree information based on the image quality information, and
determining, based on the image quality information and an image mask of at least one local region, first local restoration degree information corresponding to the at least one local region,
wherein the providing of the restoration degree confirmation interface for the first image based on the first restoration degree information comprises:
providing a global restoration degree confirmation interface in the restoration degree confirmation interface based on the first global restoration degree information, and
determining, based on the first local restoration degree information corresponding to at least local region, at least one corresponding local restoration degree confirmation interface in the restoration degree confirmation interface, and
wherein, in response to an adjustment instruction to the first restoration degree information input by the user through the restoration degree confirmation interface, the determining of the second restoration degree information of the first image comprises:
determining second restoration degree information of the first image in response to at least one of:
an adjustment instruction to the first global restoration degree information input by the user through the global restoration degree confirmation interface, or
an adjustment instruction to at least one local restoration degree information input by the user through the at least one local restoration degree confirmation interface.

11. The method of claim 9, wherein, in response to the restoration degree related instruction input by the user through the restoration degree confirmation interface, the determining of the second restoration degree information of the first image comprises:
in response to the global restoration degree related instruction input by the user through the global restoration degree confirmation interface, determining second global restoration degree information;
in response to the at least one local restoration degree related instruction input by the user through the at least one local restoration degree confirmation interface, determining at least one corresponding second local restoration degree information; and
fusing the second global restoration degree information and the at least one second local restoration degree information to obtain the second restoration degree information.

12. The method of claim 6, wherein the determining of the image quality information of the first image comprises:
acquiring depth information and/or lightness information of the first image; and
determining the image quality information of the first image based on lightness information and/or depth information.

13. The method of claim 12, wherein the determining of the image quality information of the first image based on the lightness information and/or the depth information comprises:
obtaining a first image feature based on the lightness information and/or the depth information;
performing feature extraction on the first image to obtain a second image feature; and
determining the image quality information of the first image based on the first image feature and the second image feature.

14. The method of claim 13, wherein the obtaining of the first image feature based on the lightness information and the depth information comprises:
performing feature extraction on the lightness information and the depth information to obtain a lightness feature and a depth feature, respectively;
determining, based on the lightness feature, a first weight map for compensating the depth feature;
weighting the depth feature according to the first weight map to obtain a compensated depth feature; and
fusing the lightness feature and the compensated depth feature to obtain the first image feature.

15. An electronic device comprising:
memory storing one or more computer programs; and
one or more processors communicatively coupled to the memory,
wherein the one or more computer programs include computer-executable instructions that, when executed by the one or more processors, cause the electronic device to:
acquire a first image,
determine restoration style information of the first image, and
restore the first image based on the restoration style information by using an artificial intelligence (AI) network to obtain a restored image.

16. The electronic device of claim 15, wherein the restoration style information is related to attribute information of a target object in the first image.

17. The electronic device of claim 15,
wherein the one or more computer programs further include computer-executable instructions that, when executed by the one or more processors, cause the electronic device to:
determine restoration degree information of the first image, and
wherein, in restoring of the first image based on the restoration style information by using an AI network, the one or more computer programs further include computer-executable instructions that, when executed by the one or more processors, cause the electronic device to:
restore the first image based on the restoration style information and the restoration degree information by using an AI network.

18. The electronic device of claim 17, wherein the restoration degree information is related to at least one of:
image quality of the first image; or
a restoration degree related instruction input by a user.

19. One or more non-transitory computer-readable storage media storing computer-executable instructions that, when executed by one or more processors of an electronic device, cause the electronic device to perform operations, the operations comprising:
acquiring a first image;
determining restoration style information of the first image; and
restoring the first image based on the restoration style information by using an artificial intelligence (AI) network to obtain a restored image.

20. The one or more non-transitory computer-readable storage media of claim 19, wherein the restoration style information is related to attribute information of a target object in the first image.
